(19) United States
(12) Patent Application Publication
(10) Pub. No.: US 2010/0099717 A1
(43) Pub. Date: Apr. 22, 2010

(54) SUSPENSION CONCENTRATES FOR IMPROVING THE ROOT ABSORPTION OF AGROCHEMICAL ACTIVE INGREDIENTS

(75) Inventors: Ronald Vermeer, Leverkusen (DE); Peter Baur, Schondorf (DE); Heike Hungenberg, Langenfeld (DE); Wolfgang Thielert, Odenthal (DE); Udo Reckmann, Koln (DE); Peter Marczok, Koln (DE); Isidro Bailo-Schleiermacher, Leverkusen (DE)

Correspondence Address: Baker Donelson Bearman, Caldwell & Berkowitz, PC, 555 Eleventh Street, NW, Sixth Floor, Washington, DC, 20004, US

(73) Assignee: BAYER CROPSCIENCE AKTIENGESELLSCHAFT, Monheim (DE)

(21) Appl. No.: 12/442,514

(22) PCT Filed: Sep. 18, 2007
(86) PCT No.: PCT/EP07/08101

§ 371 Date: May 11, 2009

(30) Foreign Application Priority Data
Sep. 30, 2006 (EP) 06020674.5

(51) Int. Cl. A01N 43/40; A01N 43/38; A01N 43/12; A01N 43/56

(52) U.S. Cl. 514/341; 514/336; 514/409; 514/462; 514/407

(57) ABSTRACT

It is possible to increase the uptake of active compounds from crop protection compositions using suitable adjuvants, and thus to improve the action of crop protection agents. The present invention describes suitable adjuvants, methods and compositions.

The present invention relates to improving the biological action of aqueous agrochemical suspension concentrates in soil applications by increasing the uptake of the active compound by the root using suitable adjuvants, and to their use for controlling harmful insects or phytopathogenic fungi.

This procedure has the advantage that, using the compositions according to the invention, it is possible to decrease the amount of active compound applied or, at an unchanged application rate, to achieve improved action. Additionally, it is possible to reduce water consumption to a minimum.

In this context, an adjuvant is a component which improves the biological action of the active compounds in the compositions according to the invention without for its part exhibiting a biological action. The adjuvants are preferably incorporated into the concentrated formulation of the agrochemically active compound (in-can formulation). These finished formulations help to avoid dosage errors and to improve user safety when applying agrochemical products. Furthermore, compared to the application by the tank-mix method, the unnecessary use of packaging materials is avoided.

For controlling harmful organisms, agrochemically active compounds can be applied in various ways. In addition to fourier treatment, it is also possible to treat the culture substrate, for example by spraying onto the soil, watering, side-dressing, shower drenching, overhead drenching or application using an irrigation system (drip irrigation). The culture substrate may be soil, but can also be a special substrate based on, inter alia, peat mosses, cocoa fibres, stone wool, such as, for example, Grodan®, pummis, expanded clay, such as, for example, Lecaton® or Lecadan®, clay granules, such as, for example, Seramis®, foamed plastics, such as, for example, Baystrat®, vermiculite, perlite, synthetic soil, such as, for example, Hygromull®, or combinations of these substrates. Hereinbelow, all of these culture substrates are referred to as soil. In addition to a treatment of the culture substrate, a further relevant application form is the direct addition of the active compound to the aqueous phase surrounding the root, for example by the floating-box or paddy field method. By applying active compounds into or onto the soil and directly into the aqueous phase, harmful organisms living in the soil/water are brought into contact with the active compound, and the uptake of systemic active compounds by the roots is initiated.

Various formulations for improving the action of agrochemically active compounds in fourier are already known. Thus, DE-A 10 129 855 describes oil-based suspension concentrates which, by virtue of added penetrants, improve uptake via the cuticles of the leaves. Also known are water-based suspension concentrates improving fourier uptake. Thus, WO 05/036963 describes formulations of this type which, in addition to certain fungicides, also comprise at least one penetrant. The penetrants described in these formulations suitable for fourier application are defined in that they penetrate from the aqueous spray liquor and/or the spray coating into the cuticles of the plant, thus being able to increase the mobility of active compounds in the cuticles. A method described in the literature (Baur et al., 1997, Pesticide Science 51, 131-152) may be used for determining this property. Also known are the mechanisms describing the uptake of active compounds by the cuticles of the leaves. The following publications may be mentioned by way of example: Hull, H. M. (1970) Residue Reviews 31, 1-150; Hartley, G. S., Graham-Bryce, I. L. (1980) Academic Press, London; Price, C. E., Anderson, N. H. (1985) Pestic. Sci., 16, 369-377; Kirkwood, R. C. (1993) Pestic. Sci. 38, 93-102; Holloway, P. J., Rees, R. T., Stock, D. (eds.) Springer-Verlag, Berlin (1994); Schönherr J., Baur P. (1994) Pesticide Sci. 42, 185-208. It is also known to use adjuvants for improving the mobility of active compounds in soil systems. Griffith and Miller (McMullan, P. M. (ed.) 1998, Adjuvants for Agrochemicals. Proceedings of the 5th International Symposium on Adjuvants for Agrochemicals (1998), Memphis, USA pp. 233-239 and 291-297) describe that the addition of surfactants has an effect on the interaction between soil minerals and water, thus improving the penetration of water and the active compounds transported therewith. Various non-ionic surfactants are mentioned as being suitable for this purpose. Others describe how surfactants reducing the surface tension of the spray liquor improve soil penetrations. Howell (McMullan, P. M. (ed.) 1998, Adjuvants for Agrochemicals. Proceedings of the 5th International Symposium on Adjuvants for Agrochemicals (1998), Memphis, USA pp. 247-253) describes the effect of trisilane surfactants which reduce the static surface tension to less than 30 mN/m on the horizontal and vertical mobility of permethrin in various soil types. By improving the capillary effect, more and smaller pores of the soil are reached. A comparable mechanism is described by Chung (Pesticide Science (1993), 38 (2-3), pp. 250-252) for improving the action of atrazine by addition of adjuvants.

In contrast, the effect of adjuvants on the uptake of agrochemically active compounds via the root system has hitherto not been described. The literature likewise does not mention the uptake via the root system and the associated mechanisms (Plant roots Growth, activity and interactions with soils, Peter Gregory; Blackwell Publishing (2006)).

It is an object of the present invention to provide agrochemical compositions comprising adjuvants suitable for increasing the uptake of active compounds via the root system. Moreover, these compositions should be stable enough for storage and have good biological activity.

Thus, the present invention provides the use of suitable adjuvants for increasing the uptake of active compounds via the root system. Accordingly, the present invention also provides formulations comprising these adjuvants. The present invention also provides the use of these adjuvants or these agrochemical formulations for improving the action of agrochemical compositions in soil applications, for example by spraying onto the soil, watering, side-drenching, shower drenching, overhead drenching or application using an irrigation system (drip irrigation) and in the case of direct application in the water in the case of plants being in direct contact with the aqueous phase. The invention furthermore provides the use of these formulations for controlling soil-borne harmful organisms and fourier pests.

The present invention now provides novel aqueous suspension concentrates comprising
at least one agrochemically active compound from the group of the insecticides and/or fungicides which is solid at room temperature,
at least one adjuvant,
at least one non-ionic surfactant and/or at least one anionic surfactant,
at least one antifreeze agent and
one or more additives from the groups of the antifoams, the preservatives, the antioxidants, the spreading agents, the colorants and/or thickeners.

The suspension concentrates according to the invention are referred to as being aqueous because they comprise virtually no organic solvent, in any case less than 75 g/l.

Suitable non-ionic surfactants are all compounds of this type which are usually employed in agrochemical compositions. Polyethylene oxide/polypropylene oxide block copolymers, polyethylene glycol ethers of straight-chain alcohols, reaction products of fatty acids with ethylene oxide and/or propylene oxide, furthermore polyvinyl alcohol, polyvinylpyrrolidone, mixed polymers of polyvinyl alcohol and polyvinylpyrrolidone, mixed polymers of polyvinyl acetate and polyvinylpyrrolidone and also copolymers of (meth)acrylic acid and (meth)acrylic esters, furthermore alkyl ethoxylates and alkylaryl ethoxylates which may optionally be phosphated and may optionally be neutralized with bases, polyoxyamine derivatives and nonylphenol ethoxylates may be mentioned as being preferred.

Suitable anionic surfactants are all substances of this type which are usually employed in agrochemical compositions. Preference is given to alkali metal and alkaline earth metal salts of alkylsulphonic acids or alkylaryl sulphonic acids.

A further preferred group of anionic surfactants or dispersants are salts of polystyrenesulphonic acids, salts of polyvinylsulphonic acids, salts of naphthalenesulphonic acid/formaldehyde condensates, salts of condensates of naphthalenesulphonic acid, phenolsulphonic acid and formaldehyde and also salts of ligninsulphonic acid.

Suitable antifreeze agents are all substances of this type which are usually employed in agrochemical compositions. Preference is given to urea, glycerol, propanediol and propylene glycol. Particularly preferably, the suspension concentrates according to the invention comprise an antifreeze agent from the group of the polyglycerols and polyglycerol derivatives. Polyglycerols and polyglycerol derivatives are described in DE-A 100 23 153. Very particular preference is given to the polyglycerols and polyglycerol derivatives under the trade name Synergen® GL.

The compositions according to the invention optionally comprise further additives from the group of the antifoams, the preservatives, the antioxidants, the spreaders, the colorants and/or the thickeners.

Suitable antifoams are all substances usually employed for this purpose in agrochemical compositions. Preference is given to silicone oils and magnesium stearate.

Suitable preservatives are all substances of this type usually employed for this purpose in agrochemical compositions. Examples which may be mentioned are Preventol® (Lanxess AG) and Proxel®.

Suitable antioxidants are all substances which are usually employed for this purpose in agrochemical compositions. Examples which may be mentioned are: butylated hydroxytoluene (2,6-di-t-butyl-4-methylphenol, BHT), propyl gallate, octyl gallate, dodecyl gallate, butylated hydroxyanisol, propyl paraben, sodium benzoate and nordihydroguaiaretic acid. Preference is given to butylated hydroxytoluene (2,6-di-t-butyl-4-methylphenol, BHT).

Suitable spreaders are all substances which are usually employed for this purpose in agrochemical compositions. Preference is given to polyether- or organo-modified polysiloxanes.

Suitable colorants are all substances which are usually used for this purpose in agrochemical compositions. Examples which may be mentioned are titanium dioxide, pigment-grade carbon black, zinc oxide and blue pigments and also permanent red FGR.

Suitable thickeners are all substances of this type which are usually employed in agrochemical compositions. Preference is given to silicates (such as, for example, Atagel® 50 from Engelhard) or xantan gum (such as, for example, Kelzane® S from Kelko).

In the context of the present invention, an adjuvant is a substance which improves the uptake of agrochemically active compound via the root in the plant in the test system described below:

A representative number (more than 40) seeds of a selected crop plant (tomato plants, cultivar rentita) are sown individually in cavities of perforated polystyrene tablets filled with special peat culture substrate-based seeding soil. The tablets, which float, are then placed into containers filled with a nutrient solution based on 0.1% Bayfolan® and cultivated at 25° C., 80% rel. atmospheric humidity and 12 hours of light (Na vapour lamps) until the desired plant size is reached. The solutions comprising the active compound and (potential) adjuvant are added directly to the nutrient solution of individual containers before the tablets are inserted. Twelve and nineteen days after the treatment, the tomato seedlings are harvested and extracted with acetonitrile:water in a ratio of 80:20 (v/v), and the content of imidacloprid and the relevant degradation products is determined quantitatively in a suitable manner using HPLC-MS/MS.

To this end, for example, the extracted samples are examined using an Applied Biosystems API4000 QTrap HPLC-MS/MS in the MRM mould. The HPLC system consists of an Agilent 1100 pump, column oven, degassing unit and a CTC-PAL autosampler. The samples are chromatographed on a Phenomenex GEMINI 3 μm column (length 50 mm, internal diameter 2.1 mm) in the reversed-phase mould using gradient elution (mobile phase consisting of acetonitrile/water/0.1% formic acid). MS conditions for the quantification: 256.1>209.2 (ESI+; imidacloprid) and 155.9>111.9 (ESI−; 6-CNA). The peak integrals were evaluated using an external standard and a calibration curve (required correlation coefficient r>0.99). Matrix effects are taken into account by adding a known amount of analyte to an untreated sample. Quantification limit=1 ng/ml for each analyte.

4 litres of nutrient solution are used per box. The concentration of imidacloprid is 0.1 μg of imidacloprid/ml of nutrient solution (0.1 ppm). The concentration of the adjuvants tested in the nutrient solution is between 2.5 μg/ml and 0.1 mg/ml (2.5 and 100 ppm).

As a control, the same test is carried out without any added potential adjuvant. When the adjuvants according to the invention are used, this test shows an active compound uptake which is increased by at least 20% compared to the control.

In this test, the root of the plant is in contact only with the nutrient solution. This excludes that other properties of the adjuvants, such as distribution in the culture substrate, concentration profiles, etc., may have an effect on the uptake via the roots.

Moreover, it was found that the compositions according to the invention can be prepared by mixing the components with one another and, if required, grinding the suspension formed. Accordingly, the invention furthermore provides a process for preparing the compositions according to the invention, which comprises mixing
at least one agrochemically active compound from the group of the insecticides and/or fungicides which is solid at room temperature,
at least one adjuvant,
at least one non-ionic surfactant and/or at least one anionic surfactant,
at least one antifreeze agent and
one or more additives from the groups of the antifoams, the preservatives, the antioxidants, the spreading agents, the colorants and/or thickeners
   and, if required, grinding the suspension formed.

It is extremely surprising that the suspension concentrates according to the invention have a positive effect on the uptake of agrochemically active compounds via the root system. Based on the properties of the plant root described in the literature, this was not to be expected.

It is also surprising that the adjuvants selected using the test system described cause comparable effects in the more complex soil or in other culture substrates.

It is furthermore surprising that the effects of the various adjuvants do not correlate with a lowering of the static surface tension of the spray liquor and consequently do not depend on the mobility in the soil.

Furthermore, it is surprisingly that the adjuvants which improve uptake via the root system do not necessarily increase uptake via the cuticles of the leaves, this being an indication of differing mechanisms of action.

It is furthermore surprising that the use of polyglycol as antifreeze agent shows a synergistic effect in combination with the adjuvants according to the invention, even through no effect on the uptake via the root system was found for polyglycol alone.

Finally, it is extremely surprising that the suspension concentrates according to the invention have very good stability. The adjuvants used, like the dispersants of a water-based suspension concentrate, have surface-active properties, which normally results in competition with the dispersants. Especially at high storage temperature or after storage under changing temperature conditions, this results in the suspension concentrate being destabilized. The very good stability of the suspension concentrates according to the invention can be described, for example, by dispersant stability, particle size distribution or the viscosity of the formulations.

Preferred embodiments of the subject-matter of the invention are described below.

In principle, the advantageous effect of the formulations according to the invention applies to all agrochemically active compounds, but especially to insecticidally active compounds from the classes of the neonicotinoids, the pyrethroids, the butenolides, the ketoenols, the fiproles, the anthranilamides, the mectins, the spinosyns, the organophosphates and the carbamates.

Neonikotinoids can be described by the formula (II)

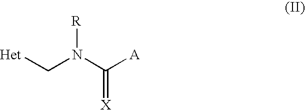

in which
Het represents a heterocycle selected from the following group of heterocycles:
   2-chloropyrid-5-yl, 2-methylpyrid-5-yl, 1-oxido-3-pyridinio, 2-chloro-1-oxido-5-pyridinio, 2,3-dichloro-1-oxido-5-pyridinio, tetrahydrofuran-3-yl, 5-methyl-tetrahydrofuran-3-yl, 2-chlorothiazol-5-yl,
R represents hydrogen, C₁-C₆-alkyl, C₂-C₆-alkenyl, C₂-C₆-alkynyl, —C(═O)—CH₃ or benzyl or together with R² represents one of the group below:
   —CH₂—CH₂—, —CH₂—CH₂—CH₂—, —CH₂—O—CH₂—, —CH₂—S—CH₂—, —CH₂—NH—CH₂—, —CH₂—N(CH₃)—CH₂— and
X represents N—NO₂, N—CN or CH—NO₂,
A represents methyl, —N(R¹)(R²) or S(R²),
in which
   R¹ represents hydrogen, C₁-C₆-alkyl, phenyl-C₁-C₄-alkyl, C₃-C₆-cycloalkyl, C₂-C₆-alkenyl or C₂-C₆-alkynyl, and
   R² represents C₁-C₆-alkyl, C₂-C₆-alkenyl, C₂-C₆-alkynyl, —C(═O)—CH₃ or benzyl,
      (see, for example, EP-A1-192 606, EP-A 2-580 533, EP-A 2-376 279, EP-A 2-235 725).

Specific mention may be made of the following preferred compounds (II-1) to (II-7) from the class of the neonikotinoids:
Thiamethoxam (II-1) has the formula

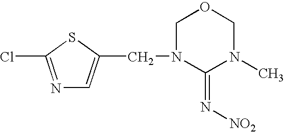

and is known from EP A2 0 580 553.
Clothianidin (II-2) has the formula

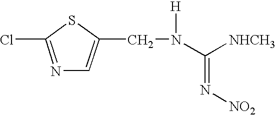

and is known from EP A2 0 376 279.
Thiacloprid (II-3) has the formula

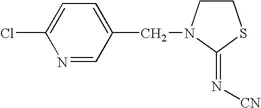

and is known from EP A2 0 235 725.
Dinotefuran (II-4) has the formula

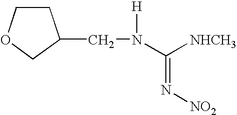

and is known from EP A1 0 649 845.
Acetamiprid (II-5) has the formula

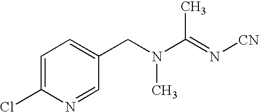

and is known from WO A1 91/04965.
Nitenpyram (II-6) has the formula

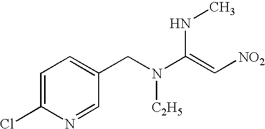

and is known from EP-A 0 302 389.
imidacloprid (II-7) has the formula

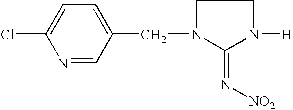

and is known from EP-A 0 192 060.

The insecticidally active compounds from the class of the pyrethroides which can be used according to the invention include, for example, substances (III-1) to (III-24):

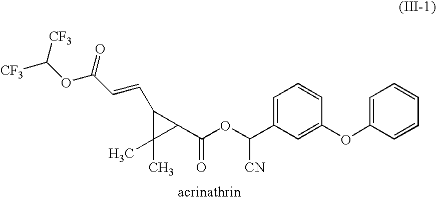

known from EP-A-048 186,

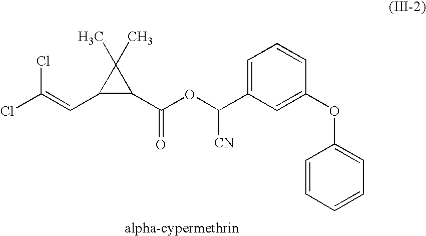

known from EP-A-067 461,

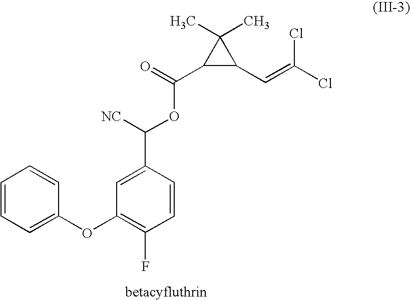

known from EP-A-206 149,

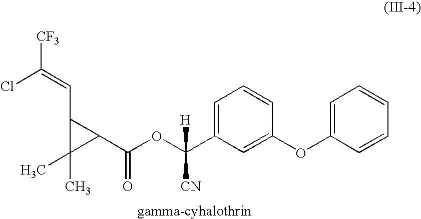

known from DE-A-2 802 962,

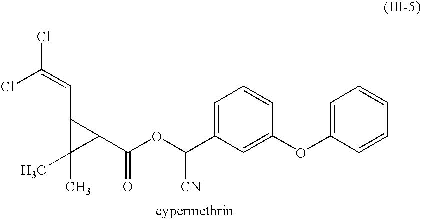

known from DE-A-2 326 077,

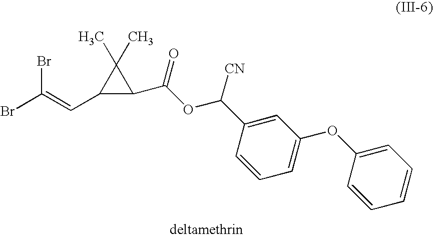

known from DE-A-2 326 077,

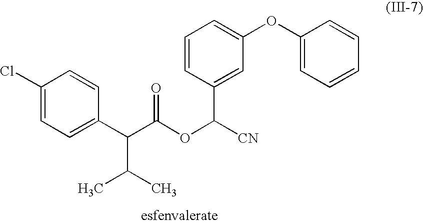

known from DE-A-2 737 297,

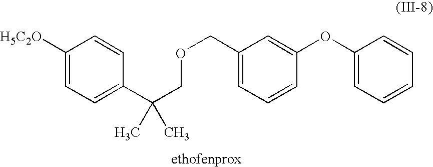

known from DE-A-3 117 510,

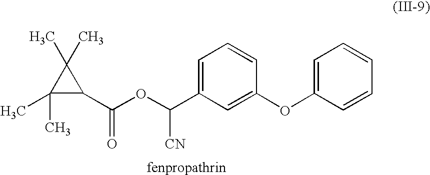

known from DE-A-2 231 312,

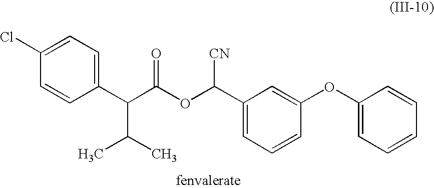

known from DE-A-2 335 347,

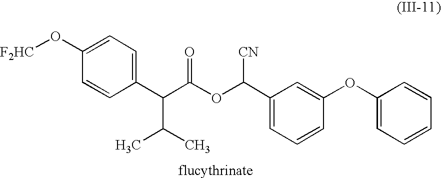

known from DE-A-2 757 066,

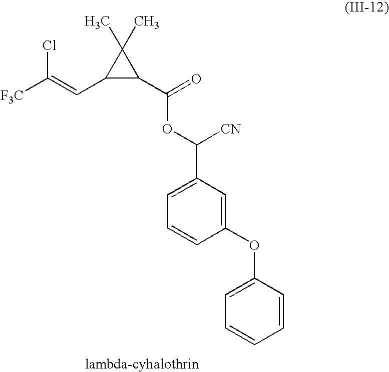

known from EP-A-106 469,

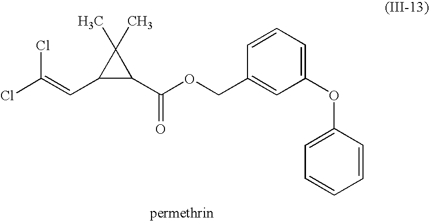

known from DE-A-2 326 077,

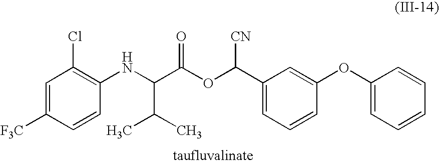

known from EP-A-038 617,

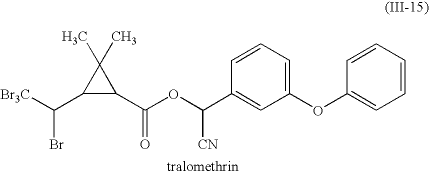

known from DE-A-2 742 546,

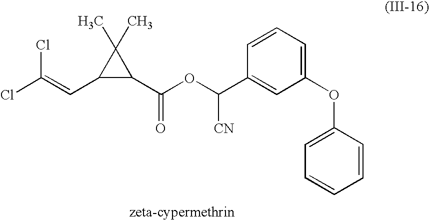

known from EP-A-026 542,

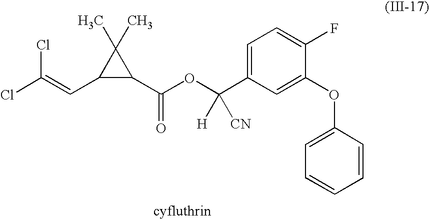

known from DE-A-27 09 264,

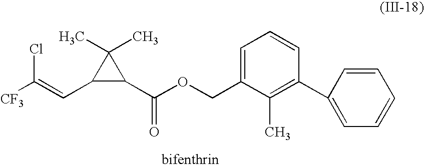

known from EP-A-049 977,

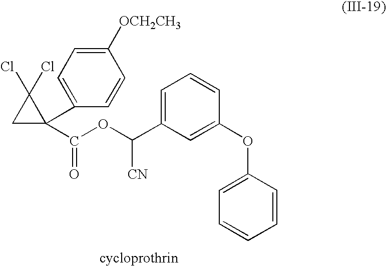

known from DE-A-2653189,

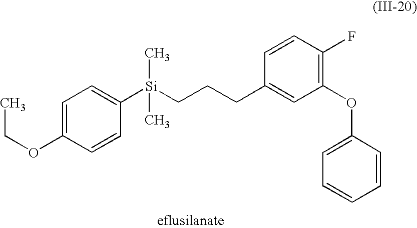

known from DE-A-36 04 781,

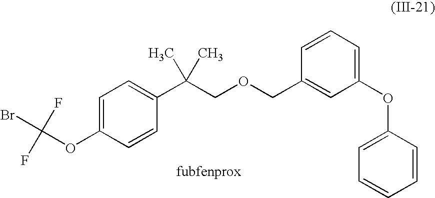

known from DE-A-37 08 231,

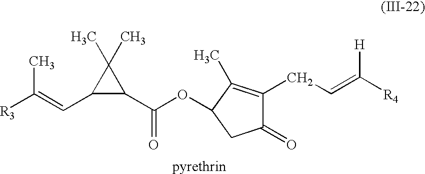

R₃=—CH₃ or —CO₂CH₃
R₄=—CH═CH₂ or —CH₃ or —CH₂CH₃
known from The Pesticide Manual, 1997, 11. Edition p. 1056,

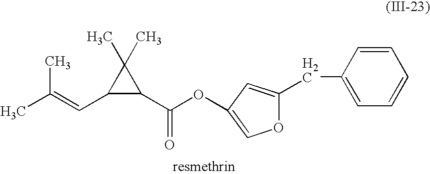

known from GB-A-1 168 797,
   and

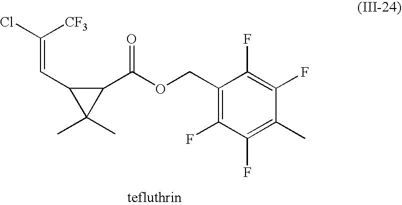

known from EP-A1 31 199.

The formula (IV) provides a general definition of the insecticidally active compounds from the class of the butenolides (known from EP-A 0 539 588) which can be used according to the invention:

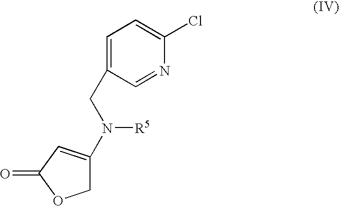

where
R⁵ represents methyl or cyclopropyl.

Specific mention may be made of the compounds (IV-1) and (IV-2).

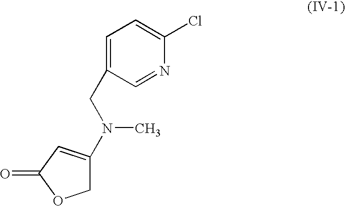

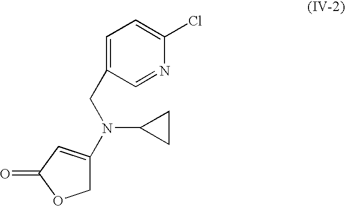

The formula (V) provides a general definition of the insecticidally active compounds from the class of the ketoenols (known from EP-A 0 539 588) which can be used according to the invention:

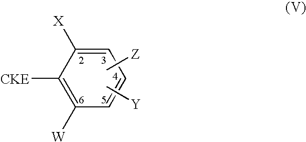

in which
W represents hydrogen, alkyl, alkenyl, alkynyl, halogen, alkoxy, halogenalkyl, halogenalkoxy or cyano,
X represents halogen, alkyl, alkenyl, alkynyl, alkoxy, alkoxyalkoxy, halogenalkyl, halogenalkoxy or cyano,
Y represents hydrogen, halogen, alkyl, alkenyl, alkynyl, alkoxy, cyano, halogenalkyl, halogenalkoxy or represents in each case optionally substituted phenyl or hetaryl,
Z represents hydrogen, halogen, alkyl, halogenalkyl, cyano, alkoxy or halogenalkoxy,
CKE represents one of the groups

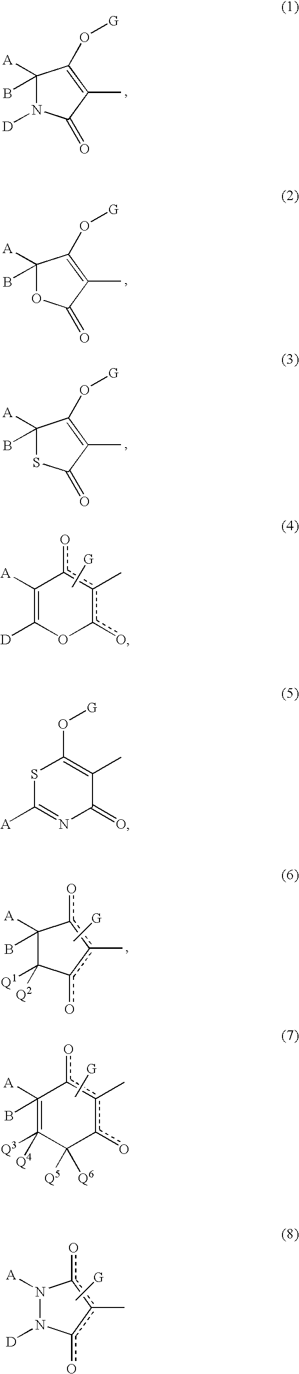

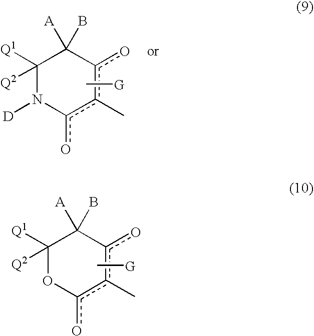

in which
A represents hydrogen, represents in each case optionally halogen-substituted alkyl, alkenyl, alkoxyalkyl, alkylthioalkyl, saturated or unsaturated, optionally substituted cycloalkyl which optionally at least one ring atom is replaced by a heteroatom, or in each case optionally halogen-, alkyl-, halogenalkyl-, alkoxy-, halogenalkoxy-, cyano- or nitro-substituted aryl, arylalkyl or hetaryl,
B represents hydrogen, alkyl or alkoxyalkyl, or
A and B together with the carbon atom in which they are attached represent a saturated or unsaturated unsubstituted or substituted cycle which optionally contains at least one heteroatom,
D represents hydrogen or an optionally substituted radical from the group consisting of alkyl, alkenyl, alkynyl, alkoxyalkyl, saturated or unsaturated cycloalkyl in which optionally one or more ring members are replaced by heteroatoms, arylalkyl, aryl, hetarylalkyl or hetaryl or
A and D together with the atoms to which they are attached represent a saturated or unsaturated cycle which is unsubstituted or substituted in the A, D moiety and optionally contains at least one (in the case of CKE-8 further) heteroatom, or
A and Q¹ together represent alkanediyl or alkenediyl, optionally substituted by hydroxyl and/or in each case optionally substituted alkyl, alkoxy, alkylthio, cycloalkyl, benzyloxy or aryl, or
D and Q¹ together with the atoms to which they are attached represent a saturated or unsaturated cycle which is unsubstituted or substituted in the D, Q¹ moiety and optionally contains at least one heteroatom,
Q¹ represents hydrogen, alkyl, alkoxyalkyl, optionally substituted cycloalkyl (in which optionally one methylene group is replaced by oxygen or sulphur) or optionally substituted phenyl,
Q², Q⁴, Q⁵ and Q⁶ independently of one another represent hydrogen or alkyl,
Q³ represents hydrogen, represents optionally substituted alkyl, alkoxyalkyl, alkylthio-alkyl, optionally substituted cycloalkyl (in which optionally one methylene group is replaced by oxygen or sulphur) or optionally substituted phenyl, or
Q¹ and Q² together with the carbon atom to which they are attached represent an unsubstituted or substituted cycle which optionally contains a heteroatom, or
Q³ and Q⁴ together with the carbon atom to which they are attached represent a saturated or unsaturated unsubstituted or substituted cycle which optionally contains a heteroatom,
G represents hydrogen (a) or represents one of the groups

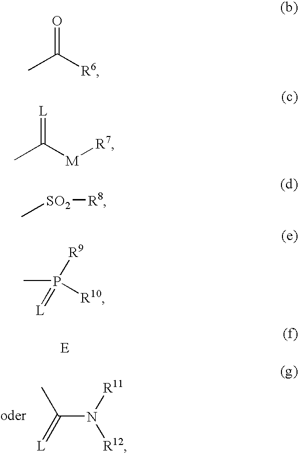

in which
E represents a metal ion equivalent or an ammonium ion,
L represents oxygen or sulphur,
M represents oxygen or sulphur,
R⁶ represents in each case optionally halogen-substituted alkyl, alkenyl, alkoxyalkyl, alkylthioalkyl, polyalkoxyalkyl or optionally halogen-, alkyl or alkoxy-substituted cycloalkyl which may be interrupted by at least one heteroatom, in each case optionally substituted phenyl, phenylalkyl, hetaryl, phenoxyalkyl or hetaryloxyalkyl,
R⁷ represents in each case optionally halogen-substituted alkyl, alkenyl, alkoxyalkyl, polyalkoxyalkyl or represents in each case optionally substituted cycloalkyl, phenyl or benzyl,
R⁸, R⁹ and R¹⁰ independently of one another represent in each case optionally halogen-substituted alkyl, alkoxy, alkylamino, dialkylamino, alkylthio, alkenylthio, cycloalkylthio or represent in each case optionally substituted diphenyl, benzyl, phenoxy or phenylthio,
R¹¹ and R¹² independently of one another represent hydrogen, in which case optionally halogen-substituted alkyl, cycloalkyl, alkenyl, alkoxy, alkoxyalkyl, represent optionally substituted phenyl, represent optionally substituted benzyl, or together with the nitrogen atom to which they are attached represent a cycle which is optionally interrupted by oxygen or sulphur.

Specific mention may be made of the compounds (V-1) to (V-5):

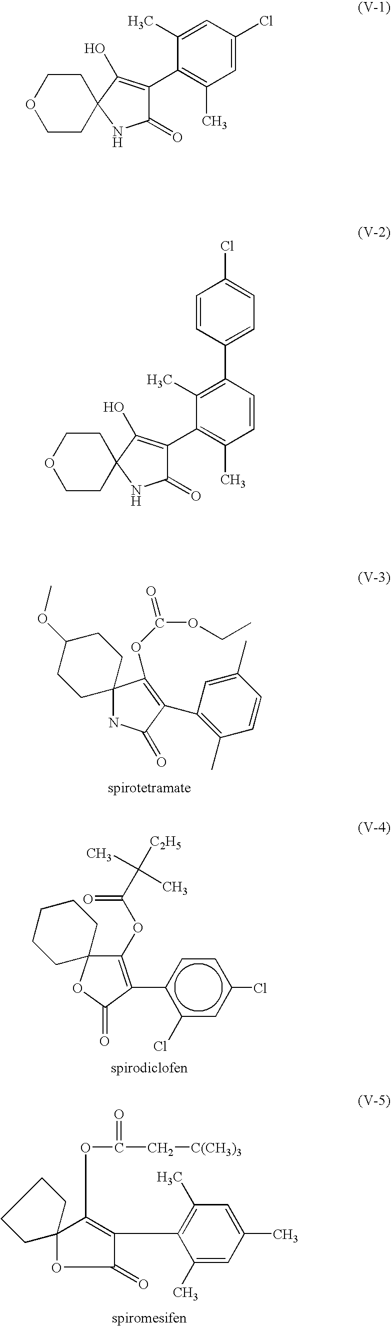

Insecticidally active compounds from the class of the fiproles which may be used according to the invention are fipronil (VI-1) and ethiprole (VI-2).

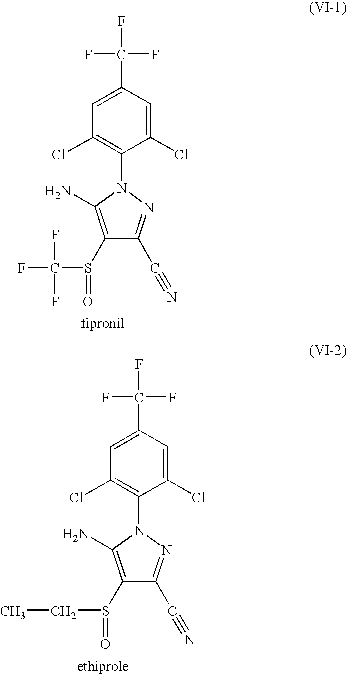

Insecticidally active compounds from the class of the anthranilamides which may used according to the invention are, for example, (VII-1) to (VII-23)

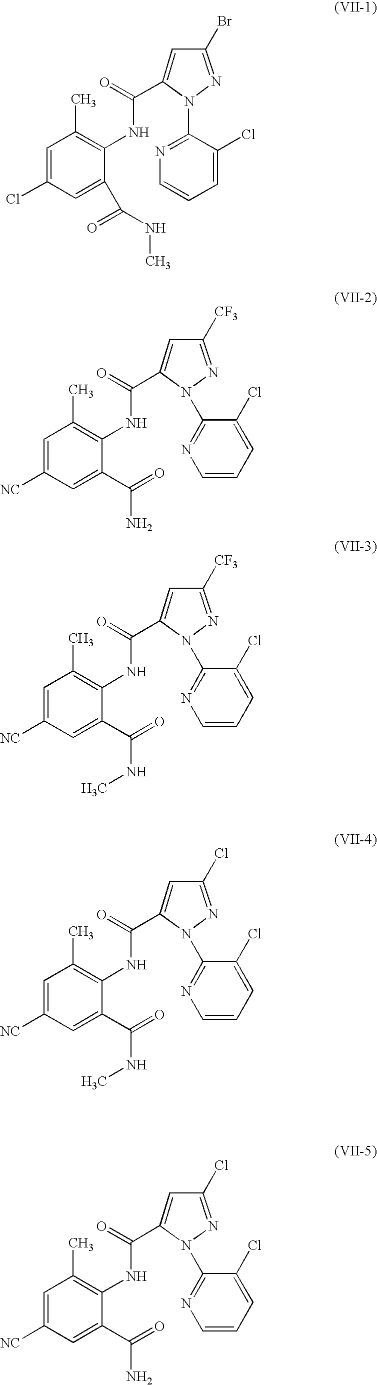

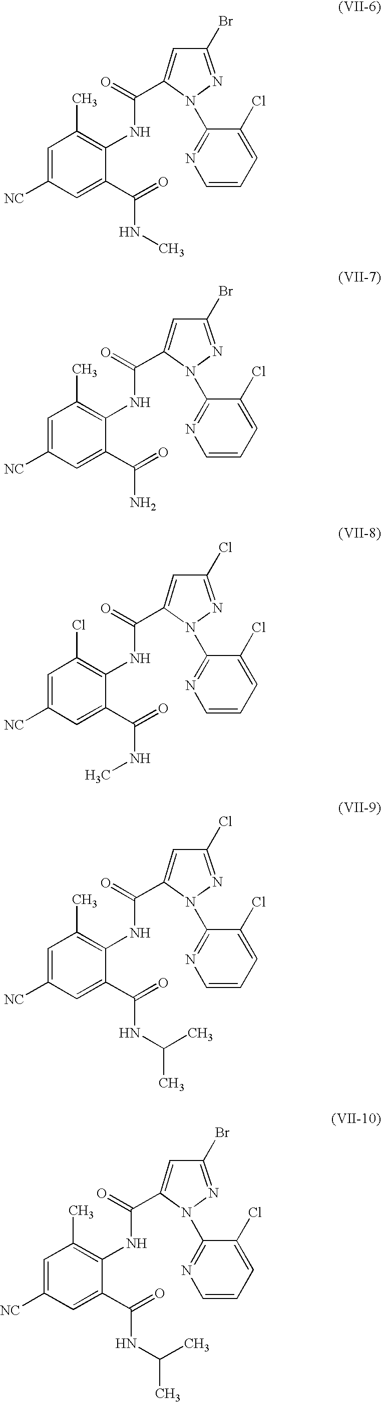

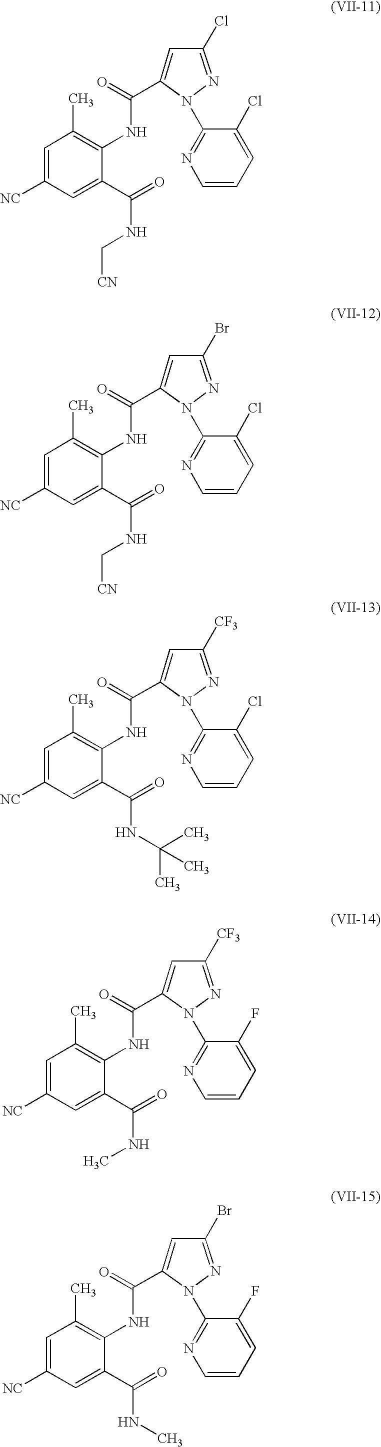

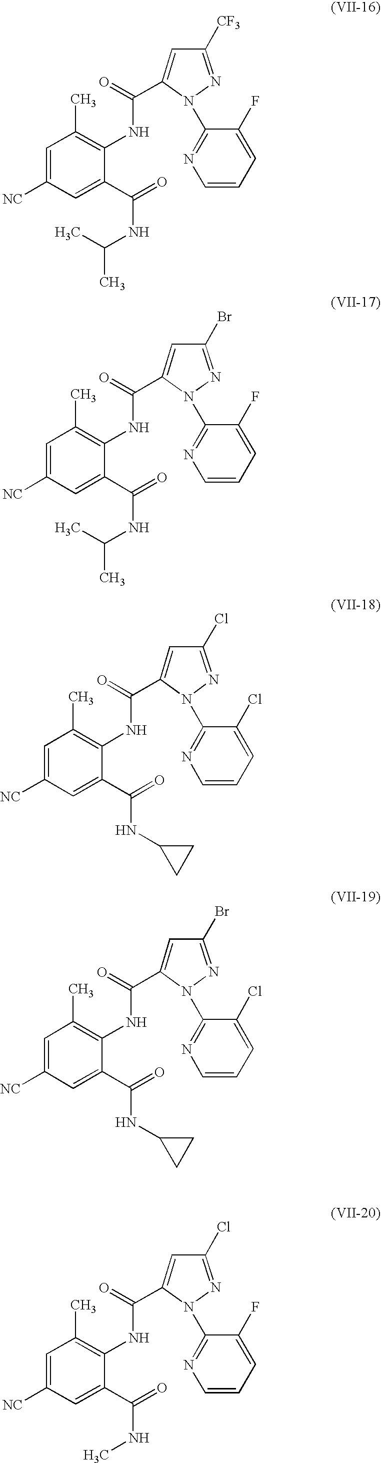

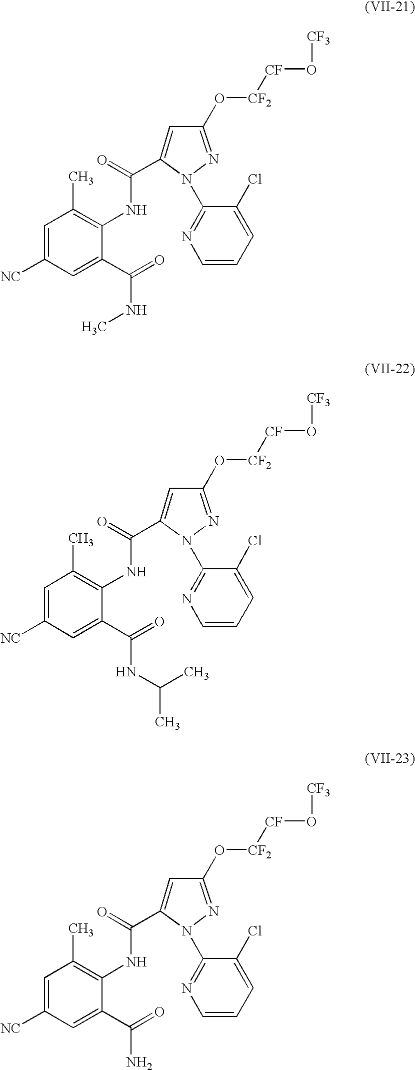

Insecticidally active compounds from the class of the mectines which may be used according to the invention are, for example,

(VIII-1) abamectin
(VIII-2) emamectin
(VIII-3) emamectin-benzoate
(VIII-4) ivermectin
(VIII-5) lepimectin
(VIII-6) milbemycin.

An insecticidally active compound from the class of the spinosynes which may be used according to the invention is, for example,

(IX-1) spinosad.

Insecticidally active compounds from the class of the organophosphates which may be used according to the invention are, for example, acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorofenvinphos, demeton-S-methyl, demeton-S-methylsulphone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorofon and vamidothion, preferably

(X-1) chloropyrifos (-methyl/-ethyl),
(X-2) cadusafos,
(X-3) acephate,
(X-4) fenamiphos
(X-5) fosthiazate and
(X-6) ethoprofos.

Insecticidally active compounds from the class of the carbamates which may be used according to the invention are, for example, alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb and triazamate, preferably

(XI-1) carbofuran,
(XI-2) aldicarb and
(XI-3) oxamyl.

In principle, the advantageous effect of these formulations according to the invention also applies to all fungicidal agrochemically active compounds. Fungicidal active compounds which may be used according to the invention are, for example:

Inhibitors of nucleic acid synthesis
benalaxyl, benalaxyl-M, bupirimate, chiralaxyl, clozylacon, dimethirimol, ethirimol, furalaxyl, hymexazol, mefenoxam, metalaxyl, metalaxyl-M, ofurace, oxadixyl, oxolinic acid
   Inhibitors of mitosis and cell division
benomyl, carbendazim, diethofencarb, fuberidazole, thiabendazole, thiophanate-methyl
   Inhibitors of respiratory chain complex II
boscalid, carboxin, fenfuram, flutolanil, furametpyr, furmecyclox, mepronil, oxycarboxin
   Inhibitors of respiratory chain complex III
azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin, trifloxystrobin
   Inhibitors of ATP production
fentin acetate, fentin chloride, fentin hydroxide
   Inhibitors of amino acid biosynthesis and protein biosynthesis
andoprim, cyprodinil, kasugamycin, kasugamycin hydrochloride hydrate, pyrimethanil
   Inhibitors of signal transduction
fludioxonil, quinoxyfen
   Inhibitors of lipid and membrane synthesis
chlozolinate, iprodione, procymidone
ampropylfos, potassium-ampropylfos, edifenphos, etridiazole, iprobenfos (IBP), isoprothiolane, pyrazophos
biphenyl
iodocarb, propamocarb, propamocarb hydrochloride, propamocarb-fosetylate
   Inhibitors of ergosterol biosynthesis
azaconazole, bitertanol, bromuconazole, cyproconazole, diclobutrazole, difenoconazole, diniconazole, diniconazole-M, epoxiconazole, etaconazole, fenarimol, fenbuconazole, fluquinconazole, flurprimidole, flusilazole, flutriafol, furconazole, furconazole-cis, hexaconazole, imazalil, imazalil sulphate, imibenconazole, ipconazole, metconazole, myclobutanil, nuarimol, oxpoconazole, paclobutrazole, penconazole, pefurazoate, prochloraz, propiconazole, prothioconazole, pyrifenox, simeconazole, tebuconazole, tetraconazole, triadimefon, triadimenol, triflumizole, triforine, triticonazole, uniconazole, voriconazole, viniconazole,
aldimorph, dodemorph, dodemorph acetate, fenpropidin, fenpropimorph, spiroxamine, tridemorph,
naftifine, pyributicarb, terbinafine
   Inhibitors of cell wall synthesis
benthiavalicarb, bialaphos, dimethomorph, flumorph, iprovalicarb, mandipropamid, polyoxins, polyoxorim
   Inhibitors of melanin biosynthesis
capropamid, diclocymet, fenoxanil, phthalid, pyroquilon, tricyclazole
   Resistance inductors
acibenzolar-S-methyl, probenazole, tiadinil
   Further fungicides
amibromdol, benthiazole, bethoxazin, capsimycin, carvone, chloropicrin, cufraneb, cymoxanil, dazomet, debacarb, diclomezine, difenzoquat, difenzoquat metilsulphate, dimetomough, dithiofencarb, ferimzone, flumetover, flusulfamide, fluopicolide, fluoroimide, fosetyl-aluminium, fosetyl-calcium, fosetyl-sodium, hexachlorobenzene, 8-hydroxyquinoline sulphate, irumamycin, methasulfocarb, metrafenone, methyl isothiocyanate, mildiomycin, natamycin, nickel dimethyl dithiocarbamate, octhilinone, oxamocarb, oxyfenthiin, pentachlorophenol and salts, 2-phenylphenol and salts, piperalin, propanosine-sodium, pyribencarb, pyrrolnitrin, quintozene, tecloftalam, tecnazene, trichlamide, valiphenal, zarilamid,
2-(2-{[6-(3-chloro-2-methylphenoxy)-5-fluoropyrimidin-4-yl]oxy}phenyl)-2-(methoxyimino)-N-methylacetamide,
2-[[[[1-[3-(1-fluoro-2-phenylethyl)oxy]phenyl]ethylidene]amino]oxy]methyl]-alpha-(methoxyimino)-N-methyl-alpha-benzacetamide,
cis-1-(4-chlorophenyl)-2-(1H-1,2,4-triazol-1-yl)cycloheptanol,
1-[(4-methoxyphenoxy)methyl]-2,2-dimethylpropyl-1H-imidazole-1-carboxylic acid,
2,3,5,6-tetrachloro-4-(methylsulphonyl)pyridine,
2-butoxy-6-iodo-3-propylbenzopyranon-4-one,
2-chloro-N-(2,3-dihydro-1,1,3-trimethyl-1H-inden-4-yl)-3-pyridinecarboxamide,
3,4,5-trichloro-2,6-pyridinedicarbonitrile,
3,4-dichloro-N-(2-cyanophenyl)isothiazole-5-carboxamide(isotianil)
3-[5-(4-chlorophenyl)-2,3-dimethylisoxazolidin-3-yl]pyridine,
5-chloro-6-(2,4,6-trifluorophenyl)-N-[(1R)-1,2,2-trimethylpropyl][1,2,4]triazolo[1,5-a]pyrimidine-7-amine,
5-chloro-7-(4-methylpiperidin-1-yl)-6-(2,4,6-trifluorophenyl)[1,2,4]triazolo[1,5-a]pyrimidine,
5-chloro-N-[(1R)-1,2-dimethylpropyl]-6-(2,4,6-trifluorophenyl) [1,2,4]triazolo[1,5-a]pyrimidine-7-amine,
methyl 2-[[[cyclopropyl[(4-methoxyphenyl)imino]methyl]thio]methyl]-alpha-(methoxymethylene)benzacetate,
methyl 1-(2,3-dihydro-2,2-dimethyl-1H-inden-1-yl)-1H-imidazole-5-carboxylate,
N-(3′,4′-dichloro-5-fluorobiphenyl-2-yl)-3-(difluoromethyl)-1-methyl-1H-pyrazole-4-carboxamide,
N-(3-ethyl-3,5,5-trimethylcyclohexyl)-3-formylamino-2-hydroxy benzamide,
N-(4-chloro-2-nitrophenyl)-N-ethyl-4-methylbenzenesulphonamide,
N-(4-chlorobenzyl)-3-[3-methoxy-4-(prop-2-yn-1-yloxy)phenyl]propanamide,
N-[(4-chlorophenyl)(cyano)methyl]-3-[3-methoxy-4-(prop-2-yn-1-yloxy)phenyl]propanamide,
N-(5-bromo-3-chloropyridin-2-yl)methyl-2,4-dichloronicotinamide,
N-[1-(5-bromo-3-chloropyridin-2-yl)ethyl]-2,4-dichloronicotinamide,
(2S)—N-[2-[4-[[3-(4-chlorophenyl)-2-propynyl]oxy]-3-methoxyphenyl]ethyl]-3-methyl-2-[(methylsulphonyl)amino]butanamide,
N-{(Z)-[(cyclopropylmethoxy)imino][6-(difluoromethoxy)-2,3-difluorophenyl]methyl}-2-benzacetamide,
N-{2-[1,1′-bi(cyclopropyl)-2-yl]phenyl}-3-(difluoromethyl)-1-methyl-1H-pyrazole-4-carboxamide,
N-{2-[3-chloro-5-(trifluoromethyl)pyridin-2-yl]ethyl}-2-(trifluoromethyl)benzamide,
N-ethyl-N-methyl-N′-{2-methyl-5-(trifluoromethyl)-4-[3-(trimethylsilyl)propoxy]phenyl}imidoformamide,
O-[1-[(4-methoxyphenoxy)methyl]-2,2-dimethylpropyl]-1H-imidazole-1-carbothioic acid,
2-amino-4-methyl-N-phenyl-5-thiazolecarboxamide,
2,4-dihydro-5-methoxy-2-methyl-4-[[[[1-[3-(trifluoromethyl)phenyl]ethylidene]amino]oxy]methyl]phenyl]-3H-1,2,4-triazol-3-one (CAS No. 185336-79-2),
N-(6-methoxy-3-pyridinyl)cyclopropane carboxamide,

Fungicides which may preferably be used according to the invention are

etridiazole, fosetyl-aluminium, propamocarb hydrochloride, metalaxyl, metalaxyl-M, benalaxyl-M, azoxystrobin, dimetomorph, pyrimethanil, carbendazim, dithiofencarb, thiophanate-methyl, prochloraz, boscalid, trifloxystrobin, fluoxastrobin, iprodione, propamocarb fosetylate, prothioconazole, triticonazole, fluquinconazole, triadimenol, iprovalicarb, fluopicolid, N-{2-[1,1′-bi(cyclopropyl)-2-yl]phenyl}-3-(difluoromethyl)-1-methyl-1H-pyrazole-4-carboxamide, N-[2-(1,3-dimethylbutyl)phenyl]-5-fluoro-1,3-dimethyl-1H-pyrazole-4-carboxamide, N-(3′,4′-dichloro-5-fluoro-1,1′-biphenyl-2-yl)-3-(difluoromethyl)-1-methyl-1H-pyrazol-4-carboxamide, N-{2-[3-chloro-5-(trifluoromethyl)-2-pyridinyl]ethyl}-2-trifluoromethylbenzamide, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl)[1,2,4]triazolo[1,5-a]pyrimidine-7-amine and 5-chloro-7-(4-methylpiperidin-1-yl)-6-(2,4,6-trifluorophenyl)[1,2,4]triazolo[1,5-a]pyrimidine.

Examples of adjuvants according to the invention which may be mentioned are especially the following substances and compositions:
(I-1) Terminally capped alkoxylated fatty alcohols and terminally capped alkoxylated straight-chain alcohols, commercially available, for example, in the product series Plurafac®; preference is given to ethoxylated and/or butoxylated fatty alcohols and terminally capped ethoxylated and/or butoxylated straight-chain alcohols (where, here and below, “terminally capped” is to be understood as meaning that the terminal hydroxyl groups are alkylated),
(I-2) tributylphenol polyglycol ethers having 10 to 15 EO units (where EO means ethylene oxide), commercially available, for example, in the product series Sapogenat®,
(I-3) branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25 (preferably from 8 to 12) and t and u are average values, commercially available, for example, in the product series Lutensol®,
(I-4) polyalkoxylated triglycerides, where the triglyceride is preferably of vegetable origin, commercially available, for example, in the product series Crovol®,
(I-5) alkoxylated fatty amines, commercially available, for example, in the product series Armoblen®,
(I-6) sodium laureth sulphate, commercially available, for example, in the product series Genapol®,
(I-7) alkoxylated terpenes available, for example, in the product series Rhodoclean®,
(I-8) compositions comprising maize syrup, methylated soya oil and non-ionic emulsifier, commercially available, for example, in the product series Superb®.

Suitable for the methods according to the invention are compositions comprising
at least one active compound selected from the group consisting of insecticidal neonikotinoides, pyrethroides, butenolides, ketoenoles, fiproles, anthranilamides, mectines, spinosynes, organophosphates and carbamates, and/or at least one active compound selected from the fungicides mentioned above,
at least one adjuvant,
at least one non-ionic surfactant and/or at least one anionic surfactant,
at least one antifreeze agent and
one or more additives from the groups of the antifoams, the preservatives, the antioxidants, the spreading agents, the colorants and/or the thickeners.

In a preferred embodiment, compositions according to the invention comprise:
at least one active compound of the general formula (II) and/or at least one active compound selected from the group consisting of (III-1) to (III-24) and/or at least one active compound of the general formula (IV) and/or at least one active compound of the general formula (V) and/or at least one active compound selected from the group consisting of (VI-1) and (VI-2) and/or at least one active compound selected from the group consisting of (VII-1) to (VII-23) and/or at least one active compound selected from the group consisting of (VIII-1) to (VIII-6) and/or (IX-1) and/or at least one active compound from the class of the organophosphates and/or at least one active compound from the class of the carbamates,
at least one adjuvant,
at least one non-ionic surfactant and/or at least one anionic surfactant,
at least one antifreeze agent and
one or more additives from the groups of the antifoams, the preservatives, the antioxidants, the spreading agents, the colorants and/or thickeners.

In a further preferred embodiment, compositions according to the invention comprise:
at least one fungicide selected from the group consisting of etridiazol, fosetyl-aluminium, propamocarb hydrochloride, metalaxyl, metalaxyl-M, benalaxyl-M, azoxystrobin, dimetomorph, pyrimethanil, carbendazim, dithiofencarb, thiophanate-methyl, prochloraz, boscalid, trifloxystrobin, fluoxastrobin, iprodione, propamocarb fosetylate, prothioconazole, triticonazole, fluquinconazole, triadimenole, iprovalicarb, fluopicolid, N-{2-[1,1′-bi(cyclopropyl)-2-yl]phenyl}-3-(difluoromethyl)-1-methyl-1H-pyrazol-4-carboxamide, N-[2-(1,3-dimethylbutyl)phenyl]-5-fluoro-1,3-dimethyl-1H-pyrazol-4-carboxamide, N-(3′,4′-dichloro-5-fluoro-1,1′-biphenyl-2-yl)-3-(difluoromethyl)-1-methyl-1H-pyrazol-4-carboxamide, N-{2-[3-chloro-5-(trifluoromethyl)-2-pyridinyl]ethyl}-2-trifluoromethylbenzamide, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl)[1,2,4]triazolo[1,5-a]pyrimidine-7-amine and 5-chloro-7-(4-methylpiperidin-1-yl)-6-(2,4,6-trifluorophenyl)[1,2,4]triazolo[1,5-a]pyrimidine,
at least one adjuvant,
at least one non-ionic surfactant and/or at least one anionic surfactant,
at least one antifreeze agent and
one or more additives from the groups of the antifoams, the preservatives, the antioxidants, the spreading agents, the colorants and/or thickeners.

In a particularly preferred embodiment, compositions according to the invention comprise:
at least one active compound of the general formula (II) and/or at least one active compound selected from the group consisting of (III-1) to (III-24) and/or at least one active compound of the general formula (IV) and/or at least one active compound of the general formula (V) and/or at least one active compound selected from the group consisting of (VI-1) and (VI-2) and/or at least one active compound selected from the group consisting of (VII-1) to (VII-23) and/or at least one active compound selected from the group consisting of (VIII-1) to (VIII-6) and/or (IX-1) and/or at least one active compound selected from the group consisting of (X-1) to (X-6) and/or at least one active compound selected from the group consisting of (XI-1) to (XI-3),
at least one substance or composition selected from the group consisting of (I-1) to (I-8),
at least one non-ionic surfactant and/or at least one anionic surfactant,
at least one antifreeze agent and
one or more additives from the groups of the antifoams, the preservatives, the antioxidants, the spreading agents, the colorants and/or thickeners.

In a further particularly preferred embodiment, compositions according to the invention comprise:
at least one fungicide selected from the group consisting of Etridiazol, Fosetyl-Aluminium, Propamocarb Hydrochloride, metalaxyl, metalaxyl-M, benalaxyl-M, azoxystrobin, dimetomorph, pyrimethanil, carbendazim, dithiofencarb, thiophanate-methyl, prochloraz, boscalid, trifloxystrobin, fluoxastrobin, iprodione, propamocarb fosetylate, prothioconazole, triticonazole, fluquinconazole, triadimenole, iprovalicarb, fluopicolid, N-{2-[1,1′-bi(cyclopropyl)-2-yl]phenyl}-3-(difluoromethyl)-1-methyl-1H-pyrazol-4-carboxamide, N-[2-(1,3-dimethylbutyl)phenyl]-5-fluoro-1,3-dimethyl-1H-pyrazol-4-carboxamide, N-(3′,4′-dichloro-5-fluoro-1,1′-biphenyl-2-yl)-3-(difluoromethyl)-1-methyl-1H-pyrazol-4-carboxamide, N-{2-[3-chloro-5-(trifluoromethyl)-2-pyridinyl]ethyl}-2-trifluoromethylbenzamide, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl)[1,2,4]triazolo[1,5-a]pyrimidine-7-amine and 5-chloro-7-(4-methylpiperidin-1-yl)-6-(2,4,6-trifluorophenyl)[1,2,4]triazolo[1,5-a]pyrimidine,
at least one substance or composition selected from the group consisting of (I-1) to (I-8),
at least one non-ionic surfactant and/or at least one anionic surfactant,
at least one antifreeze agent and
one or more additives from the groups of the antifoams, the preservatives, the antioxidants, the spreading agents, the colorants and/or thickeners.

The compositions according to the invention comprise
generally from 1 to 60% by weight of one or more of the agrochemically active compounds which may be used according to the invention, preferably from 5 to 50% by weight and particularly preferably from 10 to 30% by weight,
generally from 1 to 50% by weight of at least one adjuvant according to the invention, preferably from 2 to 30% by weight and particularly preferably from 5 to 20% by weight,
generally from 1 to 20% by weight of at least one non-ionic and/or at least one anionic surfactant, preferably from 2.5 to 10% by weight,
generally from 1 to 20% by weight of antifreeze agent, preferably from 5 to 15% by weight,
generally from 0.1 to 20% by weight of additives from the groups of the antifoams, the preservatives, the antioxidants, the spreading agents, the colorants and/or thickeners, preferably from 0.1 to 15% by weight.

In general, preference is given to certain combinations of active compounds and adjuvants listed in the table below, where each combination is preferred per se:

| | Active | |
|---|---|---|
| # | compound | Adjuvant |
| 1 | (II-7) | Alkoxylated fatty amine |
| 2 | (II-7) | Alkoxylated terpenes |
| 3 | (II-7) | Terminally capped alkoxylated fatty alcohols and terminally capped |
| | | alkoxylated straight-chain alcohols |
| 4 | (II-7) | Sodium laureth sulphate |
| 5 | (II-7) | Polyalkoxylated triglycerides |
| 6 | (II-7) | Tributylphenol polyglycol ethers having 10 to 15 EO units |
| 7 | (II-7) | Branched alkanol alkoxylates of the formula |
| | | CH₃—(CH₂)ₜ—CH₂—O—(—CH₂—CH₂—O—)ᵤ—H, in which t represents the numbers |
| | | from 9 to 10.5 and u represents numbers from 6 to 25 |
| 8 | (II-7) | Compositions comprising maize syrup, methylated soya oil and non-ionic |
| | | emulsifier |
| 9 | (IV-1) | Alkoxylated fatty amine |
| 10 | (IV-1) | Alkoxylated terpenes |
| 11 | (IV-1) | Terminally capped alkoxylated fatty alcohols and terminally capped |
| | | alkoxylated straight-chain alcohols |
| 12 | (IV-1) | Sodium laureth sulphate |
| 13 | (IV-1) | Polyalkoxylated triglycerides |
| 14 | (IV-1) | Tributylphenol polyglycol ethers having 10 to 15 EO units |
| 15 | (IV-1) | Branched alkanol alkoxylates of the formula |
| | | CH₃—(CH₂)ₜ—CH₂—O—(—CH₂—CH₂—O—)ᵤ—H, in which t represents the numbers |
| | | from 9 to 10.5 and u represents numbers from 6 to 25 |
| 16 | (IV-1) | Compositions comprising maize syrup, methylated soya oil and non-ionic |
| | | emulsifier |
| 17 | (V-3) | Alkoxylated fatty amine |
| 18 | (V-3) | Alkoxylated terpenes |
| 19 | (V-3) | Terminally capped alkoxylated fatty alcohols and terminally capped |
| | | alkoxylated straight-chain alcohols |
| 20 | (V-3) | Sodium laureth sulphate |
| 21 | (V-3) | Polyalkoxylated triglycerides |
| 22 | (V-3) | Tributylphenol polyglycol ethers having 10 to 15 EO units |
| 23 | (V-3) | Branched alkanol alkoxylates of the formula |
| | | CH₃—(CH₂)ₜ—CH₂—O—(CH₂—CH₂—O—)ᵤ—H, in which t represents the numbers |
| | | from 9 to 10.5 and u represents numbers from 6 to 25 |
| 24 | (V-3) | Compositions comprising maize syrup, methylated soya oil and non-ionic |
| | | emulsifier |
| 25 | (VI-1) | Alkoxylated fatty amine |
| 26 | (VI-1) | Alkoxylated terpenes |
| 27 | (VI-1) | Terminally capped alkoxylated fatty alcohols and terminally capped |
| | | alkoxylated straight-chain alcohols |
| 28 | (VI-1) | Sodium laureth sulphate |
| 29 | (VI-1) | Polyalkoxylated triglycerides |
| 30 | (VI-1) | Tributylphenol polyglycol ethers having 10 to 15 EO units |
| 31 | (VI-1) | Branched alkanol alkoxylates of the formula |
| | | CH₃—(CH₂)ₜ—CH₂—O—(—CH₂—CH₂—O—)ᵤ—H, in which t represents the numbers |
| | | from 9 to 10.5 and u represents numbers from 6 to 25 |
| 32 | (VI-1) | Compositions comprising maize syrup, methylated soya oil and non-ionic |
| | | emulsifier |

The suspension concentrates according to the invention are prepared by mixing the particular ratios desired of the components with one another. The components may be mixed with one another in any order. Expediently, the solid components are employed in a finely ground state. However, it is also possible to subject the suspension formed after mixing of the components initially to a coarse grinding then to a fine grinding so that the mean particle size is below 20 μm. Preferred are suspension concentrates in which the solid particles have a mean particle size of from 1 to 10 μm.

When carrying out the process according to the invention, the temperatures may be varied within a certain range. In general, the process is carried out at temperatures between 10° C. and 60° C., preferably between 15° C. and 40° C.

Suitable for carrying out the process according to the invention are customary mixers and grinders employed for producing agrochemical formulations.

The compositions according to the invention are formulations which are stable even after prolonged storage at elevated temperatures or in the cold, since no crystal growth is observed. By dilution with water, they can be converted into homogeneous spray liquors.

The application rate of the compositions according to the invention can be varied within a relatively wide range. It depends on the agrochemically active compounds in question and their content in the compositions.

The insecticidal compositions of the invention, in combination with good plant tolerance, favourable toxicity to warm-blooded animals and high compatibility with the environment, are suitable for protecting plants and plant organs, for increasing the harvest yields, for improving the quality of the harvested material and for controlling animal pests, more particularly insects, arachnids, helminths, nematodes and mollusks, which are encountered in agriculture, in horticulture, in forests, in gardens and leisure facilities. They may be preferably employed as crop protection agents. They are active against normally sensitive and resistant species and against all or some stages of development. The abovementioned pests include:

From the order of the Anoplura (Phthiraptera), for example, Damalinia spp., Haematopinus spp., Linognathus spp., Pediculus spp., Trichodectes spp.

From the class of the Arachnida, for example, Acarus siro, Aceria sheldoni, Aculops spp., Aculus spp., Amblyomma spp., Argas spp., Boophilus spp., Brevipalpus spp., Bryobia praetiosa, Chorioptes spp., Dermanyssus gallinae, Eotetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vasates lycopersici.

From the class of the Bivalva, for example, Dreissena spp.

From the order of the Chilopoda, for example, Geophilus spp., Scutigera spp.

From the order of the Coleoptera, for example, Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zealandica, Curculio spp., Cryptorhynchus lapathi, Dermestes spp., Diabrotica spp., Epilachna spp., Faustinus cubae, Gibbium psylloides, Heteronychus arator, Hylamorpha elegans, Hylotrupes bajulus, Hypera postica, Hypothenemus spp., Lachnosterna consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premnotrypes spp., Psylliodes chrysocephala, Ptinus spp., Rhizobius ventralis, Rhizopertha dominica, Sitophilus spp., Sphenophorus spp., Sternechus spp., Symphyletes spp., Tenebrio molitor, Tribolium spp., Trogoderma spp., Tychius spp., Xylotrechus spp., Zabrus spp.

From the order of the Collembola, for example, Onychiurus armatus.

From the order of the Dermaptera, for example, Forficula auricularia.

From the order of the Diplopoda, for example, Blaniulus guttulatus.

From the order of the Diptera, for example, Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypoderma spp., Liriomyza spp., Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.

From the class of the Gastropoda, for example, Arion spp., Biomphalaria spp., Bulinus spp., Deroceras spp., Galba spp., Lymnaea spp., Oncomelania spp., Succinea spp.

From the class of the helminths, for example, Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp, Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

It is further possible to control protozoa, such as Eimeria.

From the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp.

From the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma piri, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fagaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosoma spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodium, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii.

From the order of the Hymenoptera, for example, Diprion spp., Hoplocampa spp., Lasius spp., Monomorium pharaonis, Vespa spp.

From the order of the Isopoda, for example, Armadillidium vulgare, Oniscus asellus, Porcellio scaber.

From the order of the Isoptera, for example, Reticulitermes spp., Odontotermes spp.

From the order of the Lepidoptera, for example, Acronicta major, Aedia leucomelas, Agrotis spp., Alabama argillacea, Anticarsia spp., Barathra brassicae, Bucculatrix thurberiella, Bupalus piniarius, Cacoecia podana, Capua reticulana, Carpocapsa pomonella, Chematobia brumata, Chilo spp., Choristoneura fumiferana, Clysia ambiguella, Cnaphalocerus spp., Earias insulana, Ephestia kuehniella, Euproctis chrysorrhoea, Euxoa spp., Feltia spp., Galleria mellonella, Helicoverpa spp., Heliothis spp., Hofmannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mamestra brassicae, Mocis repanda, Mythimna separata, Oria spp., Oulema oryzae, Panolis flammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Thermesia gemmatalis, Tinea pellionella, Tineola bisselliella, Tortrix viridana, Trichoplusia spp.

From the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria.

From the order of the Siphonaptera, for example, Ceratophyllus spp., Xenopsylla cheopis.

From the order of the Symphyla, for example, Scutigerella immaculata.

From the order of the Thysanoptera, for example, Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni, Thrips spp.

From the order of the Thysanura, for example, Lepisma saccharina.

The phytoparasitic nematodes include, for example, Anguina spp., Aphelenchoides spp., Belonoaimus spp., Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans, Xiphinema spp.

Compositions of the invention can in addition to at least one of the active compounds mentioned above comprise other active compounds as well, such as insecticides, attractants, sterilants, bactericides, acaricides, nematicides, fungicides, growth-regulating substances, herbicides, safeners, fertilizers or semiochemicals.

Particularly favourable co-components are, for example, the following components:

### Bactericides:

bronopol, dichlorophen, nitrapyrin, nickel dimethyldithiocarbamate, kasugamycin, octhilinone, furancarboxylic acid, oxytetracycline, probenazole, streptomycin, tecloftalam, copper sulphate and other copper preparations.

### Insecticides/Acaricides/Nematicides:

Sodium channel modulators/voltage-dependent sodium channel blockers
DDT
oxadiazines,
for example indoxacarb
semicarbazone,
for example metaflumizone (BAS3201)
   Acetylcholine receptor agonists/antagonists
nicotine, bensultap, cartap
   GABA-gated chloride channel antagonists
organochlorines,
for example camphechlor, chlordane, endosulfan, gamma-HCH, HCH, heptachlor, lindane, methoxychlor
fiprol,
for example acetoprole, ethiprole, fipronil, pyrafluprole, pyriprole, vaniliprole
   Juvenile hormone mimetics,
for example diofenolan, epofenonane, fenoxycarb, hydroprene, kinoprene, methoprene, pyriproxifen, triprene
Ecdysone agonists/disrupters
diacylhydrazines,
for example chromafenozide, halofenozide, methoxyfenozide, tebufenozide
Chitin biosynthesis inhibitors
benzoylureas,
for example bistrifluoron, chlofluazuron, diflubenzuron, fluazuron, flucycloxuron, flufenoxuron, hexaflumuron, lufenuron, novaluron, noviflumuron, penfluron, teflubenzuron, triflumuron
buprofezin
cyromazine
   Oxidative phosphorylation inhibitors, ATP disrupters
diafenthiuron
organotin compounds,
for example azocyclotin, cyhexatin, fenbutatin oxide
   Oxidative phosphorylation decouplers acting by interrupting the H-proton gradient
pyrroles,
for example chlorfenapyr
dinitrophenols,
for example binapacyrl, dinobuton, dinocap, DNOC
   Site-I electron transport inhibitors
METIs,
for example fenazaquin, fenpyroximate, pyrimidifen, pyridaben, tebufenpyrad, tolfenpyrad
hydramethylnon
dicofol
   Site-II electron transport inhibitors
rotenone
   Site-III electron transport inhibitors
acequinocyl, fluacrypyrim
   Microbial disrupters of the insect gut membrane
Bacillus thuringiensis strains
   Lipid synthesis inhibitors
tetramic acids,
for example cis-3-(2,5-dimethylphenyl)-4-hydroxy-8-methoxy-1-azaspiro[4.5]dec-3-en-2-one
carboxamides,
for example flonicamid
octopaminergic agonists,
for example amitraz
   Inhibitors of magnesium-stimulated ATPase,
propargite
nereistoxin analogues,
for example thiocyclam hydrogen oxalate, thiosultap-sodium
   Biologicals, hormones or pheromones
azadirachtin, Bacillus spec., Beauveria spec., codlemone, Metarrhizium spec., Paecilomyces spec., thuringiensin, Verticillium spec.
   Active compounds with unknown or non-specific mechanisms of action
fumigants,
for example aluminium phosphide, methyl bromide, sulphuryl fluoride
antifeedants,
for example cryolite, flonicamid, pymetrozine
mite growth inhibitors,
for example clofentezine, etoxazole, hexythiazox
amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin

The compositions of the invention can further comprise synergists. Synergists are compounds which boost the action of the active compounds, without it being necessary for the synergist added to be active itself.

The compositions of the invention can further comprise inhibitors which reduce degradation of the active compound after application.

The formulation is employed in a customary manner adapted to it. Treatment according to the invention of the plants and plant parts with the compositions is carried by soil treatment, for example, as described above.

As already mentioned above, it is possible to treat all plants and their parts according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering methods, if appropriate in combination with conventional methods (Genetically Modified Organisms), and parts thereof are treated.

With particular preference, plants of the plant cultivars which are in each case commercially available or in use are treated according to the invention. Plant cultivars are to be understood as meaning plants having novel properties (“traits”) which have been obtained by conventional breeding, by mutagenesis or by recombinant DNA techniques. They can be cultivars, bio- and genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or expansions of the activity spectrum and/or a boost to the activity of the compositions of the invention, better plant growth, increased tolerance to high or low temperatures, increased tolerance to drought or to water or soil salt content, increased flowering performance, easier harvesting, accelerated maturation, higher harvest yields, higher quality and/or higher nutritional value of the harvested products, better keeping properties and/or processability of the harvested products are possible, which exceed the effects which were actually to be expected.

The transgenic plants or plant cultivars (obtained by genetic engineering) which are preferably to be treated according to the invention include all plants which, by virtue of the genetic modification, received genetic material which imparts particularly advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better keeping properties and/or processability of the harvested products. Further and particularly emphasized examples of such traits are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, sugar beet, tomatoes, peas and other vegetable varieties, cotton, tobacco, oilseed rape and also fruit plants (with the fruits apples, pears, citrus fruits and grapes), and particular emphasis is given to maize, soya beans, potatoes, cotton, tobacco and oilseed rape. Traits that are emphasized in particular are increased defence of the plants against insects, arachnids, nematodes and slugs and snails by virtue of toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (referred to hereinbelow as “Bt plants”). Traits that are also particularly emphasized are the increased defence of the plants against fungi, bacteria and viruses by systemic acquired resistance (SAR), systemin, phytoalexins, elicitors and resistance genes and correspondingly expressed proteins and toxins. Traits that are further particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya beans), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars which have these genetic traits, or genetic traits still to be developed, and which will be developed and/or marketed in the future.

The plants listed can be treated according to the invention in a particularly advantageous manner with the compositions of the invention. The preferred ranges stated above also apply to the treatment of these plants. Particular emphasis is given to the treatment of plants with the compositions specifically mentioned in the present text.

In domestic, hygiene and stored-product protection, the compositions are also suitable for controlling animal pests, particularly insects, arachnids and mites, which are found in enclosed spaces such as, for example, dwellings, factory halls, offices, vehicle cabins and the like. They can be employed alone or in combination with other active compounds and auxiliaries in domestic insecticide products for controlling these pests. They are active against sensitive and resistant species and against all developmental stages. These pests include:

From the order of the Scorpionidea, for example, Buthus occitanus.

From the order of the Acarina, for example, Argas persicus, Argas reflexus, Bryobia ssp., Dermanyssus gallinae, Glyciphagus domesticus, Ornithodorus moubat, Rhipicephalus sanguineus, Trombicula alfreddugesi, Neutrombicula autumnalis, Dermatophagoides pteronissimus, Dermatophagoides forinae.

From the order of the Araneae, for example, Aviculariidae, Araneidae.

From the order of the Opiliones, for example, Pseudoscorpiones chelifer, Pseudoscorpiones cheiridium, Opiliones phalangium.

From the order of the Isopoda, for example, Oniscus asellus, Porcellio scaber.

From the order of the Diplopoda, for example, Blaniulus guttulatus, Polydesmus spp.

From the order of the Chilopoda, for example, Geophilus spp.

From the order of the Zygentoma, for example, Ctenolepisma spp., Lepisma saccharina, Lepismodes inquilinus.

From the order of the Blattaria, for example, Blatta orientalies, Blattella germanica, Blattella asahinai, Leucophaea maderae, Panchlora spp., Parcoblatta spp., Periplaneta australasiae, Periplaneta americana, Periplaneta brunnea, Periplaneta fuliginosa, Supella longipalpa.

From the order of the Saltatoria, for example, Acheta domesticus.

From the order of the Dermaptera, for example, Forficula auricularia.

From the order of the Isoptera, for example, Kalotermes spp., Reticulitermes spp.

From the order of the Psocoptera, for example, Lepinatus spp., Liposcelis spp.

From the order of the Coleoptera, for example, Anthrenus spp., Attagenus spp., Dermestes spp., Latheticus oryzae, Necrobia spp., Ptinus spp., Rhizopertha dominica, Sitophilus granarius, Sitophilus oryzae, Sitophilus zeamais, Stegobium paniceum.

From the order of the Diptera, for example, Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga carnaria, Simulium spp., Stomoxys calcitrans, Tipula paludosa.

From the order of the Lepidoptera, for example, Achroia grisella, Galleria mellonella, Plodia interpunctella, Tinea cloacella, Tinea pellionella, Tineola bisselliella.

From the order of the Siphonaptera, for example, Ctenocephalides canis, Ctenocephalides felis, Pulex irritans, Tunga penetrans, Xenopsylla cheopis.

From the order of the Hymenoptera, for example, Camponotus herculeanus, Lasius fuliginosus, Lasius niger, Lasius umbratus, Monomorium pharaonis, Paravespula spp., Tetramorium caespitum.

From the order of the Anoplura, for example, Pediculus humanus capitis, Pediculus humanus corporis, Pemphigus spp., Phylloera vastatrix, Phthirus pubis.

From the order of the Heteroptera, for example, Cimex hemipterus, Cimex lectularius, Rhodinus prolixus, Triatoma infestans.

In the field of domestic insecticides, they are used alone or in combination with other suitable active compounds, such as phosphoric esters, carbamates, pyrethroids, neonicotinoids, growth regulators or active compounds from other known classes of insecticides.

The fungicidal compositions according to the invention have very good fungicidal properties and can be used for controlling phytopathogenic fungi, such as Plasmodiophoromycetes, Oomycetes, Chytridiomycetes, Zygomycetes, Ascomycetes, Basidiomycetes, Deuteromycetes, etc.

Some pathogens causing fungal diseases which come under the generic names listed above may be mentioned as examples, but not by way of limitation:

Diseases caused by powdery mildew pathogens, such as, for example,
Blumeria species, such as, for example, Blumeria graminis;
Podosphaera species, such as, for example, Podosphaera leucotricha;
Sphaerotheca species, such as, for example, Sphaerotheca fuliginea;
Uncinula species, such as, for example, Uncinula necator;
Diseases caused by rust disease pathogens, such as, for example,
Gymnosporangium species, such as, for example, Gymnosporangium sabinae
Hemileia species, such as, for example, Hemileia vastatrix;
Phakopsora species, such as, for example, Phakopsora pachyrhizi and Phakopsora meibomiae;
Puccinia species, such as, for example, Puccinia recondita or Puccinia triticina;
Uromyces species, such as, for example, Uromyces appendiculatus;
Diseases caused by pathogens from the group of the Oomycetes, such as, for example,
Bremia species, such as, for example, Bremia lactucae;
Peronospora species, such as, for example, Peronospora pisi or P. brassicae;
Phytophthora species, such as, for example Phytophthora infestans;
Plasmopara species, such as, for example, Plasmopara viticola;
Pseudoperonospora species, such as, for example, Pseudoperonospora humuli or Pseudoperonospora cubensis;
Pythium species, such as, for example, Pythium ultimum;
Leaf blotch diseases and leaf wilt diseases caused, for example, by
Alternaria species, such as, for example, Alternaria solani;
Cercospora species, such as, for example, Cercospora beticola;
Cladiosporium species, such as, for example, Cladiosporium cucumerinum;
Cochliobolus species, such as, for example, Cochliobolus sativus
(conidia form: Drechslera, Syn: Helminthosporium);
Colletotrichum species, such as, for example, Colletotrichum lindemuthanium;
Cycloconium species, such as, for example, Cycloconium oleaginum;
Diaporthe species, such as, for example, Diaporthe citri;
Elsinoe species, such as, for example, Elsinoe fawcettii;
Gloeosporium species, such as, for example, Gloeosporium laeticolor;
Glomerella species, such as, for example, Glomerella cingulata;
Guignardia species, such as, for example, Guignardia bidwelli;
Leptosphaeria species, such as, for example, Leptosphaeria maculans;
Magnaporthe species, such as, for example, Magnaporthe grisea;
Mycosphaerella species, such as, for example, Mycosphaerella graminicola;
Phaeosphaeria species, such as, for example, Phaeosphaeria nodorum;
Pyrenophora species, such as, for example, Pyrenophora teres;
Ramularia species, such as, for example, Ramularia collo-cygni;
Rhynchosporium species, such as, for example, Rhynchosporium secalis;
Septoria species, such as, for example, Septoria apii;
Typhula species, such as, for example, Typhula incarnata;
Venturia species, such as, for example, Venturia inaequalis;
Root and stem diseases caused, for example, by
Corticium species, such as, for example, Corticium graminearum;
Fusarium species, such as, for example, Fusarium oxysporum;
Gaeumannomyces species, such as, for example, Gaeumannomyces graminis;
Rhizoctonia species, such as, for example Rhizoctonia solani;
Tapesia species, such as, for example, Tapesia acuformis;
Thielaviopsis species, such as, for example, Thielaviopsis basicola;
Ear and panicle diseases (including maize cobs) caused, for example, by
Alternaria species, such as, for example, Alternaria spp.;
Aspergillus species, such as, for example, Aspergillus flavus;
Cladosporium species, such as, for example, Cladosporium spp.;
Claviceps species, such as, for example, Claviceps purpurea;
Fusarium species, such as, for example, Fusarium culmorum;
Gibberella species, such as, for example, Gibberella zeae;
Monographella species, such as, for example, Monographella nivalis;
Diseases caused by smut fungi, such as, for example,
Sphacelotheca species, such as, for example, Sphacelotheca reiliana;
Tilletia species, such as, for example, Tilletia caries;
Urocystis species, such as, for example, Urocystis occulta;
Ustilago species, such as, for example, Ustilago nuda;
Fruit rot caused, for example, by
Aspergillus species, such as, for example, Aspergillus flavus;
Botrytis species, such as, for example, Botrytis cinerea;
Penicillium species, such as, for example, Penicillium expansum;
Sclerotinia species, such as, for example, Sclerotinia sclerotiorum;
Verticilium species, such as, for example, Verticilium alboatrum;
Seed- and soil-borne rot and wilt diseases, and also diseases of seedlings, caused, for example, by
Fusarium species, such as, for example, Fusarium culmorum;
Phytophthora species, such as, for example, Phytophthora cactorum;
Pythium species, such as, for example, Pythium ultimum;
Rhizoctonia species, such as, for example, Rhizoctonia solani;
Sclerotium species, such as, for example, Sclerotium rolfsii;
Cancerous diseases, galls and witches' broom caused, for example, by
Nectria species, such as, for example, Nectria galligena;
Wilt diseases caused, for example, by
Monilinia species, such as, for example, Monilinia laxa;
Deformations of leaves, flowers and fruits caused, for example, by
Taphrina species, such as, for example, Taphrina deformans;
Degenerative diseases of woody plants caused, for example, by
Esca species, such as, for example, Phaemoniella clamydospora;
Diseases of flowers and seeds caused, for example, by
Botrytis species, such as, for example, Botrytis cinerea;
Diseases of plant tubers caused, for example, by
Rhizoctonia species, such as, for example, Rhizoctonia solani;
Diseases caused by bacteriopathogens, such as, for example,
Xanthomonas species, such as, for example, Xanthomonas campestris pv. oryzae;
Pseudomonas species, such as, for example, Pseudomonas syringae pv. lachrymans;
Erwinia species, such as, for example, Erwinia amylovora.

Preference is given to controlling the following diseases of soya beans:

fungal diseases on leaves, stems, pods and seeds caused, for example, by
alternaria leaf spot (Alternaria spec. atrans tenuissima), anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.)), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), powdery mildew (Microsphaera diffusa), pyrenochaeta leaf spot (Pyrenochaeta glycines), rhizoctonia aerial, foliage, and web blight (Rhizoctonia solani), rust (Phakopsora pachyrhizi), scab (Sphaceloma glycines), stemphylium leaf blight (Stemphylium botryosum), target spot (Corynespora Cassiicola)
Fungal diseases on roots and the stem base caused, for example, by
black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmopspora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia Southern blight (Sclerotinia rolfsii), thielaviopsis root rot (Thielaviopsis basicola).

### Determination of the Efficiency of Various Adjuvants for Root Uptake of Imidacloprid—Examples of Adjuvants According to the Invention

45 seeds of tomato plants, Sorte Rentita, were sown individually into the cavities of perforated polystyrene tablets filled with special seeding soil based on peat culture substrate. The floats were then placed into containers with nutrient solution based on 0.1% Bayfolan® and cultivated at 25° C., 80% rel. atmospheric humidity and 12 hours of light until the desired plant size was reached. Before the tablets were introduced, the appropriate solutions were added directly to the nutrient solution of individual boxes. Twelve and nineteen days after the treatment, tomato seedlings were harvested and extracted, and the imidacloprid content was analysed by HPLC MS/MS.

Adjuvants according to the invention are defined as those substances which increased uptake by more than 20%, compared to the control.

TABLE 1
Improvement of imidacloprid uptake in tomato plants
after addition of 0.008 mg of imidacloprid and 8 mg of
adjuvant per plant. When mixtures were added, the
amount was in each case 8 mg.

| | Imidacloprid (ng/g of seedlings) |
|---|---|
| | Sum of the contents 12 and 19 days |
| Adjuvant | after application |
| Armoblen ® 615 | 314.4 |
| Sapogenat ® T500 | 230.1 |
| Lutensol ® TO 20 | 228.8 |
| Sapogenat ® T130 | 207.1 |
| Plurafac ® LF 132 | 204.4 |
| Rhodoclean ® MSC | 199.1 |
| Superb ® (HC) MSO | 182.9 |
| Crovol ® CR70G | 182.1 |
| Lutensol ® TO 10 | 180.3 |
| Aerosol ® OTB | 180.1 |
| Control (no potential adjuvant) | 142.7 |
| Geropon ® SDS | 105.1 |
| Control (no imidacloprid) | 2.3 |

### PREPARATION EXAMPLES

To prepare a suspension concentrate, initially all liquid components are mixed with one another. In the next step, the solids are added and the mixture is stirred until a homogeneous suspension is formed. The homogeneous suspension is subjected initially to coarse grinding and then to fine grinding, resulting in a solution in which 90% of the solids particles have a particle size below 10 μm. Subsequently, Kelzan® S and water are added at room temperature with stirring. This gives a homogeneous suspension concentrate.

The examples below illustrate the invention without limiting it in any aspect. All data are in % by weight.

TABLE 2
Compositions of formulations according to the invention

| | Example | | | | | | | |
|---|---|---|---|---|---|---|---|---|
| | 1 | 2 | 3 | 4 | 5 | 6 | 7 | 8 |
| Imidacloprid | 21.6 | 21.6 | 21.6 | 21.6 | 21.6 | 21.6 | 21.6 | 21.6 |
| Kelzan ® S | 0.1 | 0.6 | 0.4 | 0.1 | 0.2 | 0.4 | 0.4 | 0.2 |
| Preventol ® | 0.08 | 0.08 | 0.08 | 0.08 | 0.08 | 0.08 | 0.08 | 0.08 |
| D7 | | | | | | | | |
| Proxel ® GXL | 0.12 | 0.12 | 0.12 | 0.12 | 0.12 | 0.12 | 0.12 | 0.12 |
| Anti foam | 0.5 | 0.1 | 0.1 | 0.1 | 0.1 | 0.1 | 0.1 | 0.1 |
| Atlox ® 4913 | 4.5 | 4.5 | 4.5 | 4.5 | 4.5 | 4.5 | 4.5 | 4.5 |
| Emulgator | 1.5 | 1.5 | 1.5 | 1.5 | 1.5 | 1.5 | 1.5 | 1.5 |
| PS 54 | | | | | | | | |
| Glycerol | 10 | 10 | 10 | 10 | 10 | 10 | 10 | 10 |
| Synergen ® | | | | | 10 | | | |
| GL 5 | | | | | | | | |
| Crovol ® | | | | | | | | |
| CR 70 G | | | | | | | | |
| Lutensol ® | | | | | | | | |
| TO 10 | | | | | | | | |
| Lutensol ® | | | | | | | | 10 |
| TO 20 | | | | | | | | |
| Sapogenat ® | | | | | | | 15 | |
| T 130 | | | | | | | | |
| Sapogenat ® | 12.5 | | | | | | | |
| T 500 | | | | | | | | |
| Armoblen ® | | | | 10 | | | | |
| 615 | | | | | | | | |
| Plurafac ® | | | 10 | | | | | |
| LF 132 | | | | | | | | |
| Rhodoclean ® | | 20 | | | | | | |
| MSC | | | | | | | | |
| Superb ® HC | | | | | | 10 | | |
| Na benzoate | | | | | | | | |
| Water | 49.1 | 41.5 | 51.7 | 52 | 51.9 | 51.7 | 46.7 | 51.9 |

| | Example | | | | | | |
|---|---|---|---|---|---|---|---|
| | 9 | 10 | 11 | 12 | 13 | 14 | 15 |
| Imidacloprid | 21.6 | 21.6 | 21.6 | 21.6 | 21.6 | 21.6 | 21.6 |
| Kelzan ® S | 0.6 | 0.1 | 0.2 | 0.1 | 0.2 | 0.2 | 0.2 |
| Preventol ® D7 | 0.08 | 0.08 | 0.08 | 0.08 | 0.08 | 0.08 | 0.08 |
| Proxel ® GXL | 0.12 | 0.12 | 0.12 | 0.12 | 0.12 | 0.12 | 0.12 |
| Anti foam | 0.1 | 0.1 | 0.1 | 0.1 | 0.5 | 0.1 | 0.1 |
| Atlox ® 4913 | 4.5 | 4.5 | 4.5 | 4.5 | 4.5 | 4.5 | 4.5 |
| Emulgator PS 54 | 1.5 | 1.5 | 1.5 | 1.5 | 1.5 | 1.5 | 1.5 |
| Glycerol | 10 | 10 | 10 | 10 | 10 | 10 | 10 |
| Synergen ® GL 5 | | | | | | | |
| Crovol ® CR 70 G | 15 | | | | | | |
| Lutensol ® TO 10 | | | 10 | | | | |
| Lutensol ® TO 20 | | | | | | | |
| Sapogenat ® T 130 | | | | | | | |
| Sapogenat ® T 500 | | | | | | | |
| Armoblen ® 615 | | | | | | | |
| Plurafac ® LF 132 | | | | | 10 | | |
| Rhodoclean ® MSC | | 10 | | 10 | | | |
| Superb ® HC | | | | | | 20 | 10 |
| Na benzoate | | | | 2 | 2 | | 2 |
| Water | 46.5 | 52 | 51.9 | 51.8 | 49.9 | 41.9 | 49.9 |

| | Example | | | | |
|---|---|---|---|---|---|
| | 16 | 17 | 18 | 19 | 20 |
| Imidacloprid | 21.6 | 21.6 | 21.6 | 21.6 | 21.6 |
| Kelzan ® S | 0.1 | 0.6 | 0.4 | 0.1 | 0.2 |
| Preventol ® D7 | 0.08 | 0.08 | 0.08 | 0.08 | 0.08 |
| Proxel ® GXL | 0.12 | 0.12 | 0.12 | 0.12 | 0.12 |
| Anti foam | 0.5 | 0.1 | 0.1 | 0.1 | 0.1 |
| Atlox ® 4913 | 4.5 | 4.5 | 4.5 | 4.5 | 4.5 |
| Emulgator PS 54 | 1.5 | 1.5 | 1.5 | 1.5 | 1.5 |
| Glycerol | 5 | 5 | 5 | 5 | 5 |
| Synergen ® GL 5 | 7.5 | 7.5 | 7.5 | 7.5 | 7.5 |
| Crovol ® CR 70 G | 10 | | | | |
| Lutensol ® TO 10 | | | | | |
| Lutensol ® TO 20 | | | | 10 | |
| Sapogenat ® T 130 | | 10 | | | |
| Sapogenat ® T 500 | | | | | |
| Armoblen ® 615 | | | | | |
| Plurafac ® LF 132 | | | 10 | | |
| Rhodoclean ® MSC | | | | | 10 |
| Superb ® HC | | | | | |
| Na benzoate | | | | | |
| Water | 49.1 | 49 | 49.2 | 49.5 | 49.4 |

### Comparative Example

To prepare a comparative example (suspension concentrate with surfactant which is not an adjuvant according to the invention, in the present case Geropon® SDS, cf. also Table 1), initially all liquid components are mixed with one another. In the next step, the solids are added and the mixture is stirred until a homogeneous suspension is formed. The homogeneous suspension is subjected initially to coarse grinding and then to fine grinding, resulting in a solution in which 90% of the solids particles have a particle size below 10 μm. Subsequently, Kelzan® S and water are added at room temperature with stirring. This gives a homogeneous suspension concentrate.

The examples below illustrate the invention without limiting it in any aspect. All data are in % by weight.

TABLE 3
Composition of a comparative formulation (in % by weight)

| | |
|---|---|
| Imidacloprid | 21.6 |
| Kelzan ® S | 0.1 |
| Preventol ® D7 | 0.08 |
| Proxel ® GXL | 0.12 |
| Anti foam | 0.1 |
| Atlox ® 4913 | 4.5 |
| Emulgator PS 54 | 1.5 |
| Glycerol | 10 |
| Geropon ® SDS | 10 |
| Water ® | 52 |

### Determination of the Static Surface Tension

The measurements were carried out using a commercial tensiometer from Kruess GmbH (Hamburg/Germany) and a platinum ring according to OECD Guideline No. 115. Prior to the measurement, the measuring vessel and the platinum ring were cleaned of traces of adhering chemicals using acetone. The platinum ring was additionally cleansed of traces of any surface-active substances by thorough heating. All samples were measured shortly after their preparation. For the measurements, the samples (without foam) were filled with a height of at least 1 cm into the measuring apparatus. The samples were then warmed until the measuring temperature (25° C.) was reached. The platinum ring was then immersed into the sample (about 5 mm) By lowering the sample bench, the platinum ring was then removed from the sample liquid at a constant rate of 5 mm/min in accordance with OECD Guideline No. 115. The tensile force required is measured continuously. The maximum value of the tensile force required is recorded as measured value. The ring is then again immersed below the surface, and the measurement is repeated. The test is carried out five times in total, and the mean value of all measurements is reported as surface tension [mN/m].

TABLE 4
Static surface tension of formulations according to the invention
(27 mg of SC (8 mg of active compound) in
1000 ml of water at 25° C.).

| Formulation | Surface tension (mN/m) |
|---|---|
| Example 1 | 57 |
| Example 2 | 53 |
| Example 3 | 40 |
| Example 4 | 43 |
| Example 5 | 59 |
| Example 6 | 60 |
| Example 7 | 45 |
| Example 8 | 55 |
| Example 9 | 50 |
| Water | 72 |

### Storage Stability of the Formulations According to the Invention

To examine the storage stability, 100 ml of formulation were stored under changing temperature conditions (TW) and at 54° C. for eight weeks. The changing temperature conditions are 48 hours at 30° C., reduction of the temperature over 22.5 hours at 2° C./hour to −15° C., 75 hours at −15° C., increase of the temperature over 22.5 hours at 2° C./hour to 30° C. After storage, the sample is brought to room temperature, and dispersibility, particle size and viscosity are checked.

The dispersibility (DISP) is determined according to the CIPAC MT 180 method, the particle size (Part) is measured on a Malvern Mastersizer 2000, and the dynamic viscosity (Visc) is measured at 20 s⁻¹ using a RheoStress RS 150 from Haake.

TABLE 5
Storage stability of formulations according to the invention

| | | | | 8 weeks | | | | | |
|---|---|---|---|---|---|---|---|---|---|
| | Original value | | | at 54° C. | | | 8 weeks TW | | |
| | | Part | Visc/ | DISP | Part | Visc/ | | Part | Visc/ |
| | DISP in % | in μm | mPas | In % | in μm | mPas | DISP In % | in μm | mPas |
| Example 1 | 0.1 | 6.3 | 241 | 0.1 | 5.9 | 252 | 0.1 | 4.7 | 230 |
| Example 2 | 0 | 4.7 | 304 | 0 | 6.3 | 296 | 0 | 5.2 | 296 |
| Example 3 | 0 | 4.2 | 527 | 0 | 4.3 | 356 | 0 | 4.0 | 426 |
| Example 4 | 0.1 | 8.7 | 118 | 0.1 | 8.8 | 96 | 0.1 | 8.4 | 133 |
| Example 5 | 0.1 | 2.8 | 252 | 0.1 | 5.1 | 153 | 0.1 | 3.3 | 238 |
| Example 6 | 0 | 4.2 | 285 | 0 | 3.4 | 168 | 0 | 4.4 | 282 |
| Example 7 | 0 | 4.2 | 234 | 0 | 6.5 | 285 | 0 | 4.3 | 204 |
| Example 8 | 0.1 | 5.2 | 165 | 0.1 | 7.0 | 151 | 0.1 | 4.3 | 166 |
| Example 9 | 0.1 | 2.9 | 189 | 0.1 | 5.2 | 169 | 0.1 | 7.5 | 166 |
| Example 10 | 0.1 | 3.0 | 100 | 0.1 | 7.0 | 88 | 0.1 | 3.4 | 94 |
| Example 11 | 0.1 | 4.1 | 120 | | | | | | |
| Example 12 | 0.1 | 6.5 | 342 | | | | | | |
| Example 13 | 0.1 | 4.3 | 1593 | | | | | | |
| Example 14 | 0.1 | 3.2 | 83 | | | | | | |
| Example 15 | 0.1 | 3.4 | 355 | 0.1 | 2.7 | 369 | 0.1 | 3.5 | 350 |

Application Trials with Formulations According to the Invention

Once they have reach the cotyledon stage, evenly grown bell-pepper plants of the cultivate ‘Feher’ are transplanted into 3 litre plastic pots (13.5×13.5×23.5 cm) with natural arable soil or coco fibre substrate. After transplantation, the plants are cultivated at 24° C., 70% rel. atmospheric humidity and 12 h of light (Na vapour lamps). Feeding and watering is carried out using one drip tube per pot. Every day, about 3×20 ml of fertilizer solution is applied per pot. The drench solution comprising insecticide or insecticide and adjuvant is applied 29 days after sowing after the fertilizer supply was stopped for a day. The drench solution volume is about 60 ml/pot. The drench solution is applied onto the substrate in circular form around the base of the seedling using a pipette. The drench solution comprises 0.355 mg of imidacloprid/plant. One day after the application of the drench solution, the supply of the plants with water and fertilizer solution is re-established.

To test the activity against Myzus persicae (green peach effect), bell-pepper plants are infected with a mixed population of Myzus persicae (3-leaf stage, 25 days after sowing, 4 days prior to the drench application). For the assessment of how long it takes for the effect to set in, the mortality in % is evaluated 2 days after the drench application (30-36-day-old plants). The results are listed in Tables 6 and 8. For the assessment of the persistency, 38 days after the drench application 67 day-old plants are once more inoculated as described above with Myzus persicae, and the mortality is evaluated in % separately for the upper and the lower half of the seedling 7 days after the inoculation. The results are shown in Table 7. The chosen experimental protocol uses only female aphides which, when they have reached the adult stage, produce a new aphid larva virtually every day. This results in an extremely rapid growth of the aphid population.

The number of aphids which remain on a treated plant is decisive for the re-establishment of the aphid population. As a result, significant differences in the aphid trials in the greenhouse are only found at concentrations which are very low compared to practical applications. The amount of active compound used of 0.355 mg/plant is higher by a factor of 5 than the threshold in the greenhouse trial with standard formulation without adjuvant. Accordingly, a difference of 5% in the activity is significant. Moreover, at efficacy of more than 95%, there are less than 10 aphids on the treated plants; efficacy differences of 5% are clearly recognizable in this range, since, for example, 10 female aphids (90-95% efficacy) can re-establish the population considerably more rapidly than, for example, 2-3 female aphids (>98% efficacy).

To test the activity against Liriomyza trifolii (leaf-mining fly), 6 days after the drench application adult leaf-mining flies are released for oviposition on bell-pepper plants (35 days old) under transparent cylinders. Thirteen, sixteen and twenty days after the drench application, the effect on the hatched larva is estimated in % of mined leaf area (use Example 3, Table 9).

To test the activity against Spodoptera exigua (small mottled willow), 20 days after the drench application the third leaf of each bell-pepper plant is cut off, placed into a Petri dish and populated with Spodoptera exigua larva. After the desired period of time, the effect on the larva is determined in % mortality (use Example 4, Table 10).

As control, the same test is carried out using the comparative example (comprising a surfactant which is not an adjuvant according to the invention) and using a commercial formulation without adjuvant according to the invention (prior art, Admire® 2F, Bayer CropScience). In this test, compared to the control, an increased mortality is found when adjuvants according to the invention are used. Here, the mortality is not necessarily increased at each point of time; there may only be an improvement in the initial effect or the long-term effect.

### Use Example 1

### Myzus persicae in Arable Soil

TABLE 6

| | Mortality/% |
|---|---|
| Prior art | 60 |
| Comparative example | 70 |
| Example 2 | 75 |
| Example 4 | 72.5 |
| Example 8 | 67.5 |

TABLE 7

Mortality/%

| | Lower | Higher |
|---|---|---|
| | leaves | leaves |
| Prior art | 95 | 95 |
| Comparative example | 96.5 | 94 |
| Example 1 | 99 | 99 |
| Example 2 | 99 | 99 |
| Example 3 | 99 | 99 |
| Example 4 | 99 | 99 |
| Example 6 | 99 | 98 |
| Example 7 | 96.5 | 98 |
| Example 8 | 100 | 99 |
| Example 9 | 99 | 99 |

### Use Example 2

### Myzus persicae in Coco Fibres

TABLE 8

| | Mortality/% |
|---|---|
| Prior art | 88.75 |
| Comparative example | 93.25 |
| Example 2 | 93.25 |
| Example 6 | 93.75 |
| Example 8 | 94.5 |

### Use Example 3

### Liriomyza trifolii in Coco Fibres

TABLE 9

| | Infection | | | Infection | | |
|---|---|---|---|---|---|---|
| | on leaf 1/% | | | on leaf 4/% | | |
| | | 16 | | 13 | 16 | |
| | 13 dat | dat | 20 dat | dat | dat | 20 dat |
| Prior art | 25 | 55 | 55 | 16.5 | 17.5 | 17.5 |
| Comparative example | 35 | 42.5 | 42.5 | 15 | 20 | 20 |
| Example 1 | 25 | 30 | 30 | 10 | 12.5 | 12.5 |
| Example 2 | 15 | 30 | 30 | 3 | 4 | 4 |
| Example 3 | 30 | 7.5 | 12.5 | 10 | 10 | 12.5 |
| Example 4 | 20 | 10 | 20 | 10.5 | 10.5 | 10.5 |
| Example 6 | 10.5 | 17.5 | 17.5 | 11.5 | 7.5 | 10 |
| Example 9 | 20 | 27.5 | 27.5 | 10 | 10 | 10 |

dat = days after treatment (13 dat = Evaluation 13 days after treatment)

### Use Example 4

### Spodoptera exigua in Arable Soil

TABLE 10

| | Mortality/% |
|---|---|
| Prior art | 0 |
| Example 1 | 30 |
| Example 2 | 30 |
| Example 3 | 45 |
| Example 4 | 30 |
| Example 6 | 70 |
| Example 7 | 70 |
| Example 8 | 30 |
| Example 9 | 30 |

1. Method for controlling animal pests or phytopathogenic fungi comprising applying an agrochemical composition comprising at least one agrochemically active compound to a culture substrate of a plant, wherein a composition comprising at least one adjuvant is applied.

2. Method according to claim 1 wherein said agrochemical composition comprises an aqueous suspension concentrate having a content of organic solvents of less than 75 g/l and wherein a composition comprising at least one adjuvant is applied, and further wherein the adjuvant is capable of increasing uptake of imidacloprid into shoots of a tomato plant if the plant is cultivated in a soil-free system with a nutrient solution comprising 0.1 ppm of imidacloprid and 2.5 to 100 ppm of adjuvant.

3. Method according to claim 1, wherein the adjuvant is selected from the group consisting of
terminally-capped alkoxylated fatty alcohols and terminally-capped alkoxylated straight-chain alcohols,
tributylphenol polyglycol ethers having 10 to 15 EO units, where EO means ethylene oxide,
branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25 and t and u are average values,
polyalkoxylated triglycerides,
alkoxylated fatty amines,
sodium laureth sulphate,
alkoxylated terpenes and
compositions comprising maize syrup, methylated soya oil and a non-ionic emulsifier.

4. Agrochemical composition for use in the soil, comprising:
at least one agrochemically active compound,
at least one adjuvant selected from the group consisting of
terminally-capped alkoxylated fatty alcohols and terminally-capped alkoxylated straight-chain alcohols,
tributylphenol polyglycol ethers having 10 to 15 EO units, where EO means ethylene oxide,
branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25 and t and u are average values,
polyalkoxylated triglycerides,
alkoxylated fatty amines,
sodium laureth sulphate,
alkoxylated terpenes and
compositions comprising maize syrup, methylated soya oil and a non-ionic emulsifier.

5. Composition according to claim 4, comprising an aqueous suspension concentrate having a content of organic solvent of less than 7.5% by weight based on the weight of the concentrate.

6. Composition according to claim 4, comprising
at least one non-ionic surfactant and/or at least one anionic surfactant,
at least one additive selected from the group consisting of antifreeze agents, antifoams, preservatives, antioxidants, spreading agents, colorants and/or thickeners.

7. Composition according to claim 4, comprising
from 1 to 60% by weight of at least one agrochemically active compound from the group consisting of insecticides and fungicides,
from 1 to 50% by weight of at least one adjuvant,
from 1 to 20% by weight of at least one non-ionic surfactant and/or anionic surfactant,
from 1 to 20% by weight of antifreeze agent and
from 0.1 to 20% by weight of additives selected from the group consisting of antifoams, preservatives, antioxidants, spreading agents, colorants and/or thickeners.

8. Composition according to claim 4, comprising at least one active compound selected from the group consisting of thiamethoxam, clothianidin, thiacloprid, dinotefuran, acetamiprid, nitenpyram, imidacloprid and the compounds below:

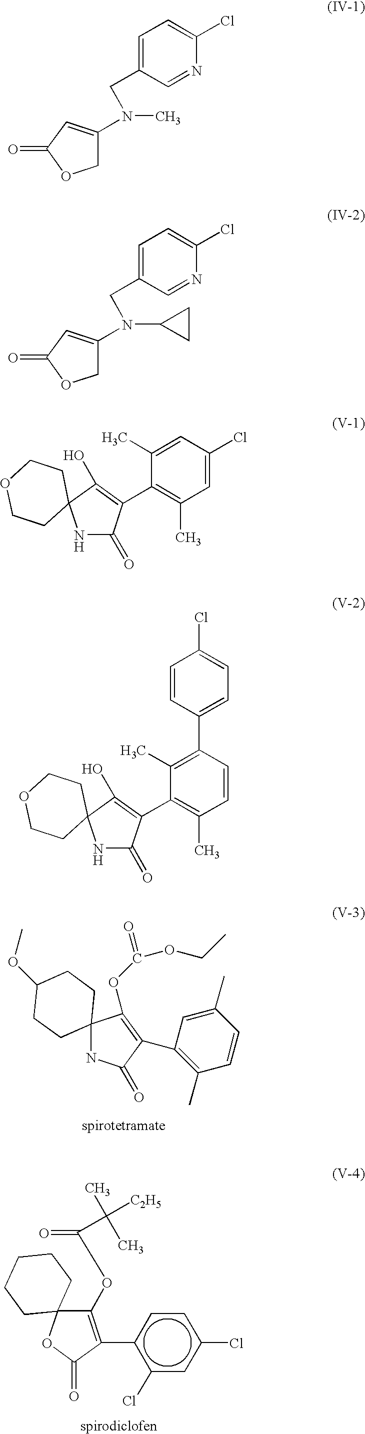

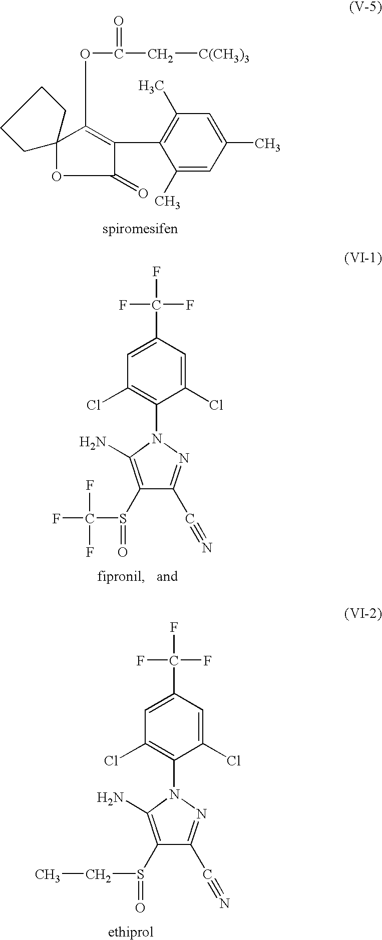

9. Composition according to claim 6, comprising as said active compound, at least imidacloprid.

10. A method for improving the action of crop protection agents in soil applications comprising using at least one adjuvant.

11. A method according to claim 10, wherein said at least one adjuvant is selected from the group consisting of
terminally-capped alkoxylated fatty alcohols and terminally-capped alkoxylated straight-chain alcohols,
tributylphenol polyglycol ethers having 10 to 15 EO units, where EO means ethylene oxide,
branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25 and t and u are average values,
polyalkoxylated triglycerides,
alkoxylated fatty amines,
sodium laureth sulphate,
alkoxylated terpenes and
compositions comprising maize syrup, methylated soya oil and a non-ionic emulsifier, is used.

12. A method according to claim 10, wherein said method involves the action of an aqueous suspension concentrate having a content of organic solvent of less than 7.5 g/l which is improved in soil applications.

13. A method according to claim 12, wherein the improved action is achieved by increased uptake of active compound by the roots.

14. Method according to claim 2 wherein the adjuvant is selected from the group consisting of
terminally-capped alkoxylated fatty alcohols and terminally-capped alkoxylated straight-chain alcohols,
tributylphenol polyglycol ethers having 10 to 15 EO units, where EO means ethylene oxide,
branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25 and t and u are average values,
polyalkoxylated triglycerides,
alkoxylated fatty amines,
sodium laureth sulphate,
alkoxylated terpenes and
compositions comprising maize syrup, methylated soya oil and a non-ionic emulsifier.

15. Composition according to claim 5 comprising at least one active compound selected from the group consisting of thiamethoxam, clothianidin, thiacloprid, dinotefuran, acetamiprid, nitenpyram, imidacloprid and the compounds below:

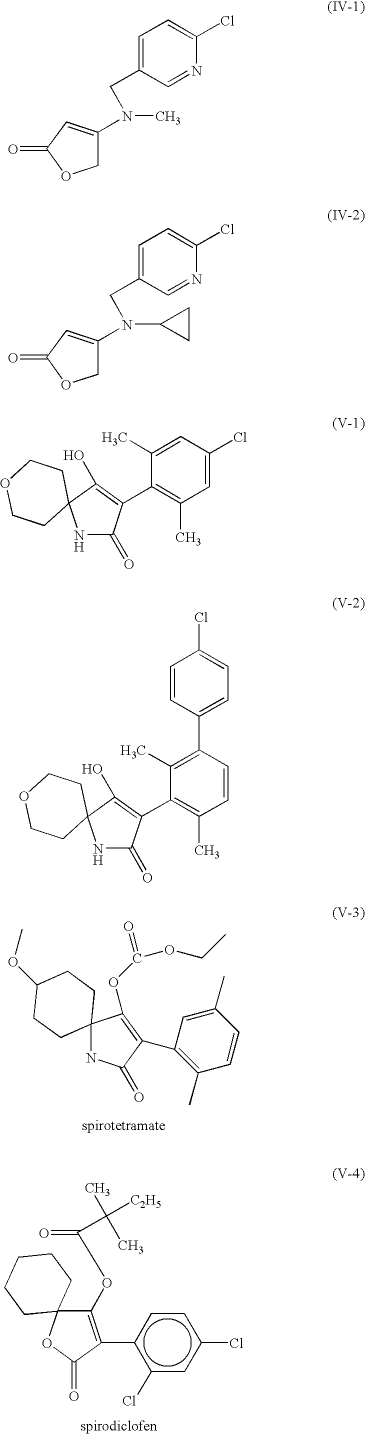

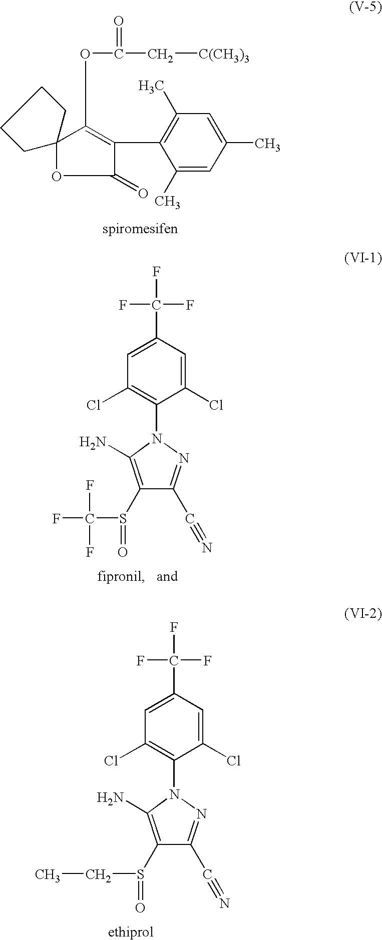

16. Composition according to claim 6 comprising at least one active compound selected from the group consisting of thiamethoxam, clothianidin, thiacloprid, dinotefuran, acetamiprid, nitenpyram, imidacloprid and the compounds below:

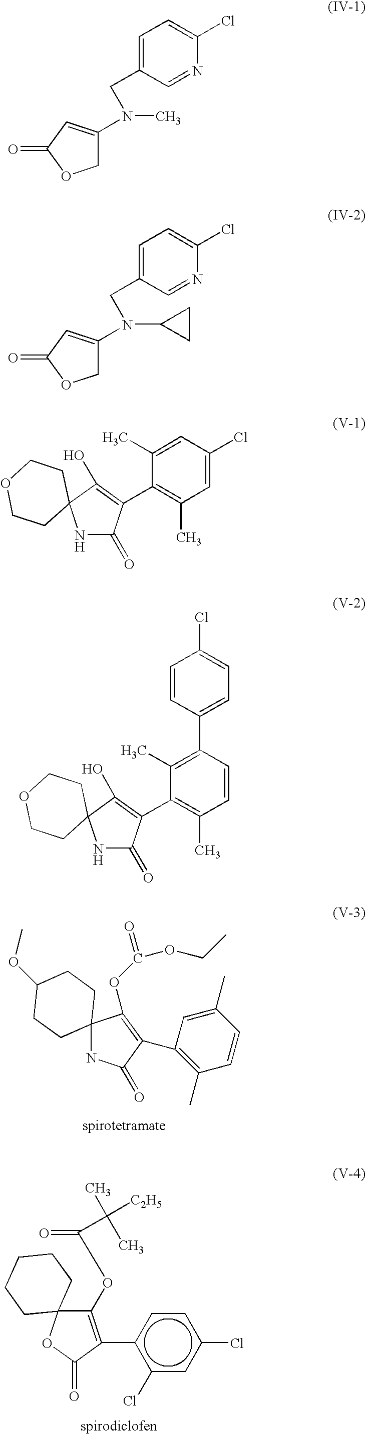

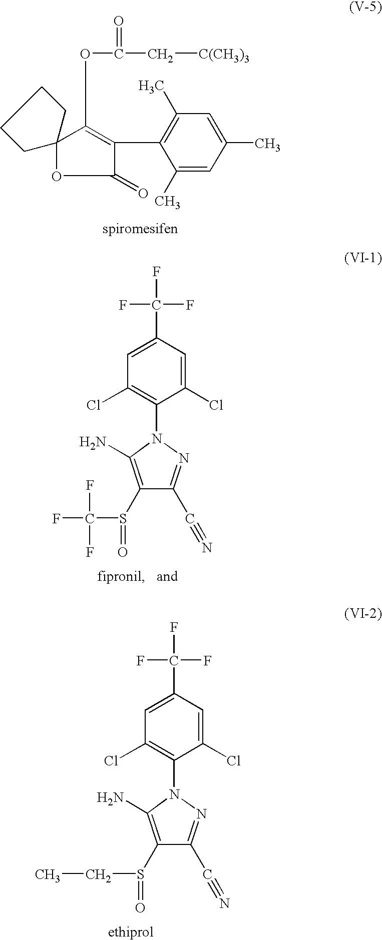

17. Composition according to claim 7, comprising at least one active compound selected from the group consisting of thiamethoxam, clothianidin, thiacloprid, dinotefuran, acetamiprid, nitenpyram, imidacloprid and the compounds below:

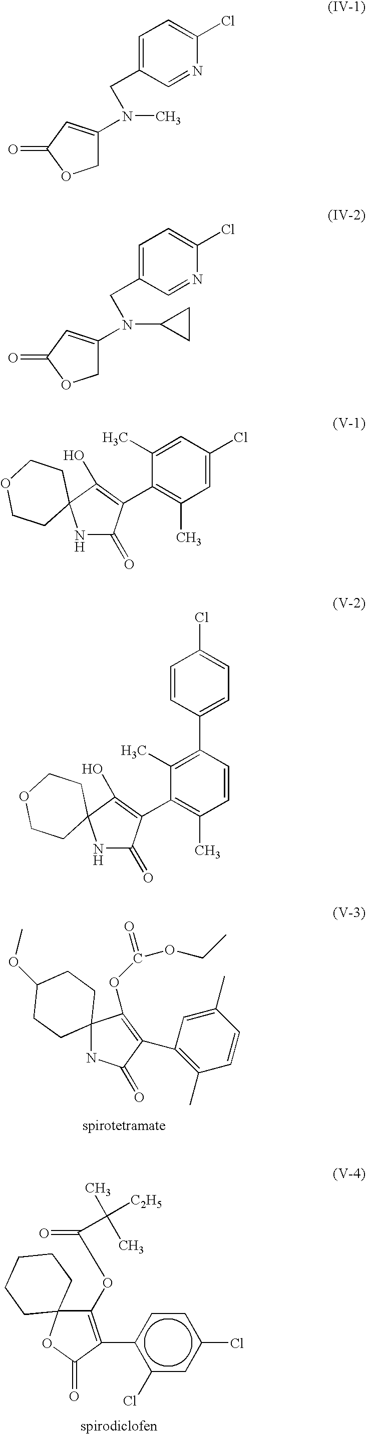

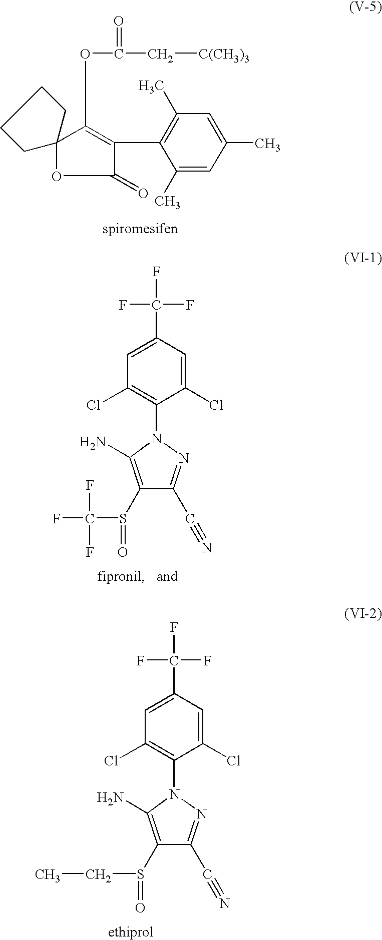

18. A method according to claim 10, wherein said method involves improved action achieved by increased uptake of active compound by the roots.

19. A method according to claim 11, wherein said method involves improved action achieved by increased uptake of active compound by the roots.

20. Composition according to claim 5, comprising
from 1 to 60% by weight of at least one agrochemically active compound from the group consisting of insecticides and fungicides,
from 1 to 50% by weight of at least one adjuvant,
from 1 to 20% by weight of at least one non-ionic surfactant and/or anionic surfactant,
from 1 to 20% by weight of antifreeze agent and
from 0.1 to 20% by weight of additives selected from the group consisting of antifoams, preservatives, antioxidants, spreading agents, colorants and/or thickeners.
